(19) United States
(12) Patent Application Publication
(10) Pub. No.: US 2015/0356704 A1
(43) Pub. Date: Dec. 10, 2015

(54) GOOD PLANAR MAPPINGS AND CONTROLLING SINGULAR VALUES WITH SEMIDEFINITE PROGRAMMING

(71) Applicant: YEDA RESEARCH AND DEVELOPMENT CO. LTD., Rehovot (IL)

(72) Inventors: Yaron LIPMAN, Rehovot (IL); Roi PORANNE, Rehovot (IL); Shahar Ziv KOVALSKY, Rehovot (IL); Ronen Ezra BASRI, Rehovot (IL); Noam AIGERMAN, Rehovot (IL)

(21) Appl. No.: 14/732,843

(22) Filed: Jun. 8, 2015

Related U.S. Application Data
(60) Provisional application No. 62/009,248, filed on Jun. 8, 2014.

(51) Int. Cl. G06T 3/00; G06T 17/10; G06T 11/20; G06F 17/50

(52) U.S. Cl. CPC G06T 3/0093; G06F 17/50; G06T 17/10; G06T 11/20

(57) ABSTRACT

A computer implemented method and system for simulating deformation of at least one physical object, the method using a processor to generate steps of: mapping the object using: a mesh of base-shapes, or, basis functions; controlling distortion of the deformation, by constraining or minimizing at least one of: isometric distortion, conformal distortion, and singular values of differentials of the mapping; and displaying the deformation via a display device.

### CROSS REFERENCE TO RELATED APPLICATIONS

This application claims the benefit of U.S. Ser. No. 62/009,248, filed on 8 Jun. 2014 which is incorporated in its entirety herein by reference.

### BACKGROUND OF THE INVENTION

Space deformation is an important tool in graphics and image processing, with applications ranging from image warping and character animation, to non-rigid registration and shape analysis. The two-dimensional case has garnered a great deal of attention in recent years, as is evident from the abundance of literature on the subject. Virtually all methods attempt to find maps that possess three key properties: smoothness, injectivity and shape preservation. Furthermore, for the purpose of warping and posing characters, the method should have interactive performance. However, there is no known method that possesses all of these properties. In the present invention, theory and tools are provided to generate maps that achieve all of these properties, including interactivity.

Previous deformation models can be roughly divided into mesh-based and meshless models. Mesh-based maps are predominantly constructed using linear finite elements, and are inherently not smooth, but can be made to look smooth by using highly dense elements. Although the methods for creating maps with controlled distortion exist, they are time-consuming, and dense meshes prohibit their use in an interactive manner. On the other hand, meshless maps are usually defined using smooth bases and hence are smooth themselves. Yet we are unaware of any known technique that ensures their injectivity and/or bounds on their distortion.

Linear transformations, or matrices, lie at the core of almost any numerical computation in science and engineering in general, and in computer graphics in particular.

Properties of matrices are often formulated in terms of their singular values and determinants. For example, the isometric distortion of a matrix, which can be formulated as its distance from the orthogonal transformation group, measures how close the singular values are to one; the condition number, or the conformal distortion of a matrix, is the ratio of its largest to smallest singular values; the stretch of a matrix, or its operator norm, is its largest singular value; a matrix is orientation preserving if its determinant is non-negative and is non-singular if its minimal singular value is positive.

### Mesh-Based Deformations

The simplest form of mesh-based deformation is done by linearly interpolating the positions of the mesh vertices, which can cause arbitrary distortions and flips. Alexa et al. 2000 [ALEXA, M., COHEN-OR, D., AND LEVIN, D. 2000. As-rigid-as-possible shape interpolation. Proc. SIGGRAPH, 157-164] suggested controlling element distortion by individually interpolating triangles in an “as-rigid-as-possible” manner, using their polar decomposition. A generalization of this approach is made by considering the mesh in special “coordinates”, which capture the local shape of the mesh with some invariance property. Other methods describe mesh deformations by discretizing a relevant variational problem directly over the mesh, using a finite-element or finite-difference perspective. Recently, several mesh-based methods that explicitly control injectivity and distortion were introduced Lipman 2012 [LIPMAN, Y. 2012. Bounded distortion mapping spaces for triangular meshes. ACM Trans. Graph. 31, 4, 108]; Schüller et al. 2013 [SCHÜLLER, C., KAVAN, L., PANOZZO, D., AND SORKINE-HORNUNG, O. 2013. Locally injective mappings. Computer Graphics Forum (proceedings of EUROGRAPHICS/ACM SIG-GRAPH Symposium on Geometry Processing) 32, 5, 125-135]. However, these methods suffer from poor performance when the density of the mesh is high.

### Meshless Deformations

While the optimization front in mesh based methods has been developed extensively, most meshless based approaches still use only simple linear blending of basis functions to generate deformations. Instead, the effort in this field of research was put into defining better basis functions. Free-Form Deformation and Thin-Plate Spline (TPS) deformation were some of the earlier examples. Later, generalized barycentric coordinates (BC) were designed to be shape aware: for example, Mean Value Coordinates (MVC).

Related to the present invention, several studies have developed methods that attain injectivity under some conditions, proving that, for mappings between convex domains, the MVC achieves injectivity. Others studies provide conditions for injective maps constructed on cube-like domains by using Warren's BC. Recently, Schneider et al. 2013 [SCHNEIDER, T., HORMANN, K., AND FLOATER, M. S. 2013. Bijective composite mean value mappings. Computer Graphics Forum 32, 5 (July), 137-146. Proceedings of SGP], constructed an algorithm that, by composting a series of MVC mappings, produces a bijection, up to pixel precision. Although their method is attractive, as it only uses the MVC basis, it produces mappings that are proven to be truly injective only on a finite set of points.

Several methods suggest using the meshless basis functions in a framework similar to the mesh-based deformation framework, instead of directly controlling the coefficients of the basis function. This is done by sampling points inside the domain to discretize and minimize an energy.

The previous methods have a considerable disadvantage: they cannot guarantee a bijection or limit the distortion. The present invention overcomes this limitation by first formulating an optimization problem that also bounds the distortion on a point set, based upon Lipman 2012. Since this does not guarantee that the distortion outside the point set is bounded, the present invention developed sufficient conditions for the deformation to satisfy distortion bounds on the entire domain. Using these techniques, the present invention is able to generate smooth maps that are not only injective, but are also sure to have bounded distortion.

### Optimization Related to Singular Values of Matrices

A number of studies in Computer Graphics deal with optimization related to singular values of matrices: Least-Squares Conformal Maps (LSCM), a convex functional that measures the distance of a 2×2 matrix from similarity, or, equivalently, minimizes the variance of the singular values; similarly, As-Rigid-As-Possible algorithms (Alexa et al. 2000) optimize a non-linear functional measuring the distance of a matrix to the rotation group, thus trying to minimize the distance of the singular values from 1. Works on surface parameterization have dealt with singular values of mappings to the plane, as these quantify desired properties. Other studies aim to minimize the ratio between singular values using a Frobenius norm relaxation.

Projection based approaches have been considered for the optimization of problems involving singular values, for example, by employing an alternating projection approach to limit singular values. More generally, one could attempt to solve constrained minimization problems using gradient projection methods, which alternate between a gradient descent step that reduces the functional, and a projection step that enforces the constraints. However, projection on multiple constraints involving singular values is, in general, non-trivial, leading to a non-convex feasibility problem that should be solved at each step. In contrast, the present method operates on convex subsets of these constraints; under proper initialization, both feasibility and monotonic reduction of the functional in each iteration are guaranteed.

Lipman 2012 provides a characterization of bounded distortion and bounded isometry spaces for 2×2 matrices. His approach, which uses a second-order cone formulation, does not extend to higher dimension. The present invention, in contrast, characterizes similar spaces of n×n matrices in any dimension using linear matrix inequalities (LMIs), which are then used in Semidefinite Programming (SDP). In 2D the constraints can be shown to coincide with Lipman's bounded isometry characterization.

The goal of the present invention is to develop a convex framework for controlling singular values of square matrices of arbitrary dimension and, hence, facilitate applications in computer graphics that require optimizing functionals defined using singular values, or that require strict control over singular values of matrices.

The challenge in controlling singular values stems from their non-linear and non-convex nature. Directly controlling singular values in higher dimensions than 2D is not straightforward. The difficulty in going beyond the two-dimensional case is demonstrated by the fact that the singular values of matrices in dimension three and higher are characterized as roots of polynomials of degree of at-least six, for which no analytic formula exists.

### SUMMARY OF THE INVENTION

The goal of the present invention is to bridge the differences between mesh and meshless methods, by providing a generic framework for making any smooth function basis suitable for deformation. This is accomplished by enabling direct control over the distortion of the Jacobian during optimization, including preservation of orientation (to avoid flips). The present method generates maps by constraining the Jacobian on a dense set of “collocation” points, using an active-set approach. It is shown that only a sparse subset of the collocation points needs to be active at every given moment, resulting in fast performance, while retaining the distortion and injectivity guarantees. Furthermore, the present invention derives a precise mathematical relationship between the density of the collocation points, the maximal distortion achieved on them, and the maximal distortion achieved everywhere in the domain of interest.

The problem of planar mapping and deformation is central in computer graphics. The present invention presents a framework for adapting general, smooth, function bases for building provably good planar mappings. The term “good” in this context means the map has no fold-overs (injective), is smooth, and has low isometric or conformal distortion.

Existing methods that use mesh-based schemes are able to achieve injectivity and/or control distortion, but fail to create smooth mappings, unless they use a prohibitively large number of elements, which slows them down. Meshless methods are usually smooth by construction, yet they are not able to avoid fold-overs and/or control distortion.

This invention constrains the linear deformation spaces induced by popular smooth basis functions, such as B-Splines, Gaussian, Thin-Plate Splines and others, at a set of collocation points, using specially tailored convex constraints that prevent fold-overs and high distortion at these points. This invention provides analysis which provides the required density of collocation points and/or constraint type, which guarantees that the map is injective and meets the distortion constraints over the entire domain of interest.

This invention provides an interactive method at reasonably complicated settings and compares favorably to other state-of-the-art mesh and meshless planar deformation methods.

The key insight of the present invention is a characterization of a complete collection of maximal convex subsets of n×n matrices with strict bounds on their singular values. By complete it means that the union of these subsets covers the entire space of n×n matrices whose singular values are bounded, and maximal means that no other convex subset of n×n matrices with bounded singular values strictly contains any one of these subsets. These convex sets are formulated as Linear Matrix Inequalities (LMIs) and can be plugged as-is into a Semidefinite Program (SDP) solver of choice. Although SDP solvers are still not as mature as more classical convex optimization tools such as linear programming, and are lagging somewhat behind in terms of time-complexity, they are already efficient enough to enable many applications in computer graphics. Furthermore, regardless of any future progress in convex optimization, the maximality property of the subsets implies that one cannot hope to enlarge these subsets and stay within the convex regime.

Additionally, many problems require matrices that preserve orientation, i.e., matrices with non-negative determinant. This non-convex requirement is naturally addressed in the present framework as well.

The formulation of the present invention is used in a number of applications in geometry processing: volumetric mesh deformations, extremal quasi-conformal mappings in three dimensions, non-rigid shape registration and averaging of rotations. This invention is experimented with these applications and it is shown that in all cases the formulation of the present invention leads to algorithms that compare favorably to state-of-art methods. FIG. 15 depicts an example of an extremal quasiconformal deformation obtained with the proposed method.

Controlling the singular values of n-dimensional matrices is often required in geometric algorithms in graphics and engineering. The present invention introduces a convex framework for problems that involve singular values. Specifically, it enables the optimization of functionals and constraints expressed in terms of the extremal singular values of matrices.

Towards this end, there is a family of convex sets of matrices whose singular values are bounded. These sets are formulated using Linear Matrix Inequalities (LMI), allowing optimization with standard convex Semidefinite Programming (SDP) solvers. It is further shown that these sets are optimal, in the sense that there exist no larger convex sets that bound singular values.

A number of geometry processing problems are described in terms of singular values. The present invention employs the proposed framework to optimize and improve upon standard approaches. The present invention is experimented with this new framework in several applications: volumetric mesh deformations, extremal quasi-conformal mappings in three dimensions, non-rigid shape registration and averaging of rotations. It is shown that in all applications the proposed approach leads to algorithms that compare favorably to state-of-art algorithms.

It is one object of the present invention to disclose a computer implemented method for simulating deformation of at least one physical object, the method using a processor to generate steps of:
mapping the object using:
   a mesh of base-shapes, or
   basis functions;
controlling distortion of the deformation, by constraining or minimizing at least one of:
   isometric distortion,
   conformal distortion, and
      singular values of differentials of the mapping; and
displaying the deformation via a display device.

It is another object of the present invention to disclose the method as defined above, wherein the controlling distortion of the deformation configured for at least one of: avoiding fold-overs of the object, smoothing the deformation, lowering the isometric distortion, and lowering the conformal distortion.

It is another object of the present invention to disclose the method as defined above, wherein the object is selected from: two-dimensional image, three-dimensional model, three-dimensional voxel grid, two-dimensional point-cloud, three-dimensional point cloud, three-dimensional surface, two-dimensional video, and three-dimensional video.

It is another object of the present invention to disclose the method as defined above, wherein the base-shapes are triangles or tetrahedrons.

It is another object of the present invention to disclose the method as defined above, wherein the constraining or minimizing of the distortion is uniform over the mapping.

It is another object of the present invention to disclose the method as defined above, wherein the constraining or minimizing of the distortion is enforced according to at least one feature selected from: spatial location and time.

It is another object of the present invention to disclose the method as defined above, further comprising step of minimizing energy of the deformation.

It is another object of the present invention to disclose the method as defined above, further comprising step of selecting the basis functions from the group consisting of: B-Splines, Gaussian, Thin-Plate Splines, and any combination thereof.

It is another object of the present invention to disclose the method as defined above, further comprising step of constraining one or more points in the mapping to at least one of: fixed location, linear subspace, and convex cone; the points responsive to user selection or to predetermined requirement of the deformation; the constraining is either hard constraining or soft constraining.

It is another object of the present invention to disclose the method as defined above, further comprising step of minimizing energy of the soft constraining.

It is another object of the present invention to disclose the method as defined above, further comprising steps of:
formulating convex subsets for the distortion; the convex subsets are selected from:
   Second Order Cone (SOC) for using a Second Order Cone Programming (SOCP) solver, or
   Linear Matrix Inequalities (LMI) for using a Semi Definite Programming (SDP) solver; and
iterative steps for the controlling of the distortion, the iterative steps comprising:
   estimating the convex subsets,
   selecting a restriction for the estimated convex subsets,
   calculating the deformation using the SOCP solver or the SDP solver for; and
   repeating the steps of the estimating, the selecting and the calculating until changes of the calculated deformation converge to a predetermined deformation-threshold.

The solvers mentioned above may be any existing solver such as for a non-limiting example: MOSEK, GUROBI, and CPLEX.

It is another object of the present invention to disclose the method as defined above, further comprising steps of:
selecting a set of collocation points (CP) within domain of the object, the CP comprising:
   a set of fixed collocation points (FCP), and
   a set of adaptive collocation-points (ACP), the ACP selected responsive to user selection or to predetermined requirement of the deformation;
estimating distortion at each of the CP;
selecting an active set of CP, responsive to a distortion-threshold for the estimated distortion;
enforcing the controlling of the distortion at the active set of the CP.

It is another object of the present invention to disclose the method as defined above, wherein the deformation is used for computer aided design (CAD) model for the object, or, for registration of at least two of the objects.

It is another object of the present invention to disclose the method as defined above, further comprising step of minimizing of at least one of:
matching energy for the registration; and
energy associated with measuring of physical- and/or geometric-properties of the CAD model.

It is another object of the present invention to disclose the method as defined above, wherein the registration is selected from: image registration, non-rigid shape registration, medical image registration, multi-modal image registration.

It is another object of the present invention to disclose the method as defined above, wherein the CAD comprising a free-form of at least one of: architecture modeling, solid design, solid modeling, and physical simulations.

It is another object of the present invention to disclose a computer system having a memory and a processor configured for simulating deformation of at least one physical object, the system comprising:
a mapping-module, stored in the memory, configured for mapping the object using:
   a mesh of base-shapes, or
   basis functions;
a controlling-module, stored in the memory, configured for controlling distortion of the deformation, by constraining or minimizing at least one of:
   isometric distortion,
   conformal distortion, and
   singular values of differentials of the mapping; and
a display device for displaying the deformation.

It is another object of the present invention to disclose the system as defined above, wherein the controlling-module comprising a minimizing-unit, stored in the memory, configured for minimizing energy of the deformation.

It is another object of the present invention to disclose the system as defined above, wherein the controlling-module comprising a map-constrain-unit, stored in the memory, configured for constraining one or more points in the mapping to at least one of: fixed location, linear subspace, and convex cone; the points responsive to user selection or to predetermined requirement of the deformation; the constraining is either hard constraining or soft constraining.

It is another object of the present invention to disclose the system as defined above, wherein the controlling-module comprising a solving-unit, stored in the memory, configured for:
formulating convex subsets for the distortion of the deformation; the convex subsets are selected from:
   Second Order Cone (SOC) for using a Second Order Cone Programming (SOCP) solver, or
   Linear Matrix Inequalities (LMI) for using a Semi Definite Programming (SDP) solver; and
iterative steps for the controlling of the distortion, the iterative steps comprising:
   estimating the convex subsets,
   selecting a restriction for the estimated convex subsets,
   calculating the deformation using the SOCP solver or the SDP solver for; and
   repeating the steps of the estimating, the selecting and the calculating until changes of the calculated deformation converge to a predetermined deformation-threshold.

It is still an object of the present invention to disclose the system as defined above, wherein the controlling-module a CP-constrain-unit, stored in the memory, configured for:
selecting a set of collocation points (CP) within domain of the object, the CP comprising:
   a set of fixed collocation points (FCP), and
   a set of adaptive collocation-points (ACP), the ACP selected responsive to user selection or to predetermined requirement of the deformation;
estimating distortion at each of the CP;
selecting an active set of CP, responsive to a distortion-threshold for the estimated distortion; and
enforcing the controlling of the distortion at the active set of the CP.

It lastly an object of the present invention to disclose the system as defined above, further comprising an interface configured for at least one of:
collecting the at least one physical object and it's required the deformation;
selecting the basis-functions;
selecting the base-shapes; and
selecting constrains for the distortion.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The subject matter presented may best be understood by reference to the following detailed description when read with the accompanying drawings in which:

FIG. 1 conceptually illustrates generating smooth bijective maps with controlled distortion at interactive rates. Top row: source image. Bottom row: examples of deformations.

FIGS. 2A, 2B and 2C conceptually illustrates several examples created with the method of the present invention; the source of each group is on the left. The smooth deformations and the controlled distortion as can be visually assessed from the spheres texture are demonstrated.

FIGS. 3A, 3B and 3C conceptually illustrate the present invention's active set approach. As the bar bends, the distortion rises above a certain threshold, causing collocation points [120] in the region to become active (FIG. 3A); these points prevent the bar from collapsing (FIG. 3B); excluding these points results in a map with singularities [130] (FIG. 3C).

FIG. 4 conceptually illustrates several more examples created with the present invention's method; due to the smoothness of the basis functions, the present invention's method is capable of handling pointwise constraints in a smooth and graceful manner.

FIG. 5 conceptually illustrates deformation of a bar using various distortion constraints using B-Splines; elaborated in the optimization method.

FIGS. 6A and 6B conceptually illustrate active-set visualization; the yellow dots represent the positions of the activated collocation points for the deformation shown; it is demonstrated that some of the points remain activated throughout to stabilize the process.

FIGS. 7A and 7B conceptually illustrate graphs showing the time required for the optimization as a function of the number of active collocation points as in FIG. 7A and the number of basis function as in 7B; a linear behaviour is shown.

FIGS. 8A, 8B, 8C and 8D conceptually illustrates deformation of a square using Thin-Plate Spline (TPS). The fold-over that caused the sub-square in the middle to disappear in the unconstrained case is demonstrated on the right, and compared to the bounded isometric distortion results on the right.

FIGS. 9A, 9B, 9C and 9D conceptually illustrate deformation of a bird drawing; the unconstrained mesh deformation resulted in an unpleasant cusp (FIG. 9B), while the yellow tri-angle in the unconstrained meshless deformation (in the blow up) almost vanished (FIG. 9C); the constrained meshless deformation avoided these problems (FIG. 9D).

FIGS. 10A, 10B, 10C and 10D conceptually illustrate deformation of a disk (FIG. 10A) according to three methods: FIG. 10B of Schüller et al. 2013 FIG. 10C of Lipman 2012 and FIG. 10D according the method of the present invention; the lack of smoothness is demonstrated in both mesh-based methods (FIGS. 10B and 10C).

FIGS. 11A and 11B conceptually illustrate deformation using 40 shape aware Gaussians and isometric distortion constraint of Kᵢₛₒ≦3. Top row shows intermediate positions of the handles [110] and the respective deformations. Bottom row compares the final deformation of the present invention FIG. 11B with Schüller et al. 2013 FIG. 11A (using the same handle positions, not shown); the cusps that occur at the handles when using Schuller's method are demonstrated.

FIGS. 12A and 12B conceptually facilitates in definition of the equation's variables.

FIG. 13 conceptually facilitates in definition of the singular values.

FIG. 14 conceptually facilitates in definition of the equation's variables.

FIG. 15 conceptually illustrates the “most conformal” mapping of a volumetric cube subject to repositioning of its eight corners the present invention's framework minimizes the maximal conformal distortion in 3D, providing a unique glimpse to extremal quasiconformal maps in higher dimensions.

FIG. 16 conceptually illustrates deformations obtained via optimizations formulated in terms of singular values; the green areas depict the positional constraints imposed on a volumetric bar; (a) optimizes the arap functional; (b),(c) the same functional while restricting either the conformal or scaled-isometric distortion; (d)-(f) repeats the comparison for the aaap functional; (g),(h) optimize the lscm functional and its l₁ version l1cm; (i) shows the extremal quasiconformal deformation satisfying the constraints. (j) shows two distributions of conformal distortion, highlighting the difference between the lscm and eqc solutions: the eqc achieves much lower maximal conformal distortion than the lscm solution (as indicated by the triangles).

FIGS. 17A and 17B conceptually illustrates volumetric parameterization mapping a volume into a cube. Color encodes the Dirichlet energy per tet. The present invention's approach as in FIG. 17A achieves lower Dirichlet energy compared to that demonstrated according to the method of Aigerman and Lipman 2013 [AIGERMAN, N., AND LIPMAN, Y. 2013. Injective and bounded distortion mappings in 3d. ACM Trans. Graph. 32, 4, 106-120].

FIG. 18 conceptually illustrates extremal quasiconformal mappings (eqc); volumetric deformations that minimize the maximal conformal distortion.

FIG. 19 conceptually illustrates a deformation model using either (i) a tetrahedral mesh enclosing the surface S (for space warping) or (ii) a mesh enclosed by the surface S (for articulation).

FIG. 20 conceptually illustrates volumetric deformations induced by fitting bone surfaces. Left source surface enclosed in volumetric tetrahedral mesh and target surface. Middle deformed bone surface and induced volumetric deformation using the bsi-ICP algorithm. Right results obtained with the baseline algorithm. Color encodes isometric distortion. bsi-ICP guarantees bounded isometric distortion and injectivity. The baseline algorithm, in contrast, tends to introduce high isometric distortion and to create artifacts on the deformed surface.

FIGS. 21A and 21B conceptually illustrate the average and maximal isometric distortion (FIG. 21A) and number of flipped tetrahedra (FIG. 21B) obtained with the baseline and bsi-ICP algorithms when applied to the anatomical surface dataset. Solid lines mark maximal values and dashed lines average values; the baseline algorithm tends to introduce high isometric distortions

FIG. 22 conceptually illustrates bsi-ICP applied to pairs of SCAPE models. Each triplet shows the source S, its deformed version Φ(S) and target T; the present invention's approach successfully registers significant non-rigid deformations, with only an initial rigid alignment as input; it may however fail (bottom row) when the Euclidean closest point leads to bad alignment.

FIG. 23 conceptually illustrates bsi-ICP applied to pairs of SHREC models; each triplet shows the source S, its deformed version Φ(S) and target T.

FIG. 24 conceptually illustrates optimization results according to Algorithm 2.

FIG. 25 conceptually illustrates the discrete Karcher energy as a function of the number of segments n used in each geodesic.

FIG. 26 conceptually illustrates typical run-times of a single iteration of Algorithm 3, used for bcd-constrained deformations of tetrahedral meshes of various sizes

FIG. 27 conceptually illustrates deformation sequence of a pair of SCAPE models. The sequence, from left to right, shows the deformation Φ(S) of the source surface S towards the target surface T; the present invention's bsi-ICP (top) is compared to the baseline algorithm (bottom); directly bounding the isometric distortion of the deformation better preserves the shape of the model during the deformation and at the end result.

FIG. 28 conceptually illustrates approximate Karcher mean; the rotation on the right approximates the Karcher mean (with equal weights) of the three rotations given in the left column; each row illustrates a geodesic.

FIGS. 29A and 29B conceptually illustrate exploring rotations different weighted combinations of the 4 fixed rotations in the corners (top). Comparing the approximate Karcher mean result as in FIG. 29A with Alexa's (2002) [ALEXA, M. 2002. Linear combination of transformations. ACM Trans. Graph. 21, 3 (July), 380-387] averaging method as demonstrated in FIG. 29B. The latter does not produce exact geodesics on the boundaries of the grid, as seen in the blowup (bottom).

FIG. 30 conceptually illustrates the system for simulating an object deformation.

FIG. 31 conceptually illustrates the method steps for simulating an object deformation.

For simplicity and clarity of illustration, elements shown are not necessarily drawn to scale, and the dimensions of some elements may be exaggerated relative to other elements. In addition, reference numerals may be repeated to indicate corresponding or analogous elements.

### DETAILED DESCRIPTION OF THE INVENTION

The following description is provided, alongside all chapters of the present invention, so as to enable any person skilled in the art to make use of the invention and sets forth the best modes contemplated by the inventor of carrying out this invention. Various modifications, however, are adapted to remain apparent to those skilled in the art, since the generic principles of the present invention have been defined specifically to provide a method and a computer implemented method and system for simulating deformation of a physical object.

The present invention provides a new computer implemented method for simulating deformation of at least one physical object, the method using a processor to generate steps of:
mapping the object using:
   a mesh of base-shapes, or
   basis functions;
controlling distortion of the deformation, by constraining or minimizing at least one of:
   isometric distortion,
   conformal distortion, and
   singular values of differentials of the mapping; and
displaying the deformation via a display device.

The present invention provides a new computer system having a memory and a processor configured for simulating deformation of at least one physical object, the system comprising:
a mapping-module, stored in the memory, configured for mapping the object using:
   a mesh of base-shapes, or
   basis functions;
a controlling-module, stored in the memory, configured for controlling distortion of the deformation, by constraining or minimizing at least one of:
   isometric distortion,
   conformal distortion, and
   singular values of differentials of the mapping; and
a display device for displaying the deformation.

The controlling distortion of the deformation configured for at least one of: avoiding fold-overs of the object, smoothing the deformation, lowering the isometric distortion, and lowering the conformal distortion.

The term “Image registration”, used herein, refers to is a process of transforming different sets of data into one coordinate system. Data may be multiple photographs, data from different sensors, times, depths, or viewpoints. Registration is used in computer vision, medical imaging, biological imaging and brain mapping, military automatic target recognition, and compiling and analyzing images and data from satellites. Registration is necessary in order to be able to compare or integrate the data obtained from these different measurements.

The term “computer-aided design (CAD)”, used herein, refers to a use of computer systems to assist in the creation, modification, analysis, or optimization of a design. CAD software is used to increase the productivity of the designer, improve the quality of design, improve communications through documentation, and to create a database for manufacturing. CAD output is often in the form of electronic files for print, machining, or other manufacturing operations.

The term “voxel grid”, used herein, refers to a value on a regular grid in three-dimensional space. A voxel is a unit of graphic information that defines a point in the three-dimensional space.

The term “point cloud”, used herein, refers to a set of data points in some coordinate system. In a three-dimensional coordinate system, these points are usually defined by X, Y, and Z coordinates, and are often intended to represent the external surface of an object.

The term “hard/soft constraints”, used herein, refers to: constraints are a set of conditions for the variables that are required to be satisfied, therefore also called “hard constraints”, whereas “soft constraints” have some variable values that are penalized in the objective function if, and based on the extent that, the conditions on the variables are not satisfied, also known as energy.

Unless specifically stated otherwise, as apparent from the following discussions, throughout the specification discussions utilizing terms such as “processing”, “computing”, “storing”, “calculating”, “determining”, “evaluating”, “measuring”, “providing”, “transferring”, “outputting”, “inputting”, “formulating”, “estimating” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

### Method Outline

Problem statement. This invention is directed to the application of “handle”-based deformation. This scenario involves a user who wishes to smoothly deform a region-of-interest Ω⊂R² in the plane, e.g. part of an image or a 2D character, under an allowable amount of distortion and without fold-overs. The user drives the deformation by positioning handles [110] inside the domain, and manipulating them in order to define positional constraints. The present invention's algorithm will supply the map that conforms best to the handles, while not violating the distortion constraints at any point x=(x,y) inside Ω. The ideal deformation f:Ω→R² can be found as the solution to the general problem:

$$\begin{matrix}{min}_{f} {E}_{pos} ( f ) + λ {E}_{reg} ( f ) & ( 1 ) \\ s . t . D ( f ; x ) \leq {K}_{max} , ∀ x ∈ Ω & ( 2 )\end{matrix}$$

where Eₚₒₛ is the positional constraints energy, E_{reg} is a regularization term, which controls the smoothness of the deformation, and D(f;x) is a measure of the distortion of f at point x (to be defined). Being infinite-dimensional with infinite number of constraints, the problem in (1)-(2) is intractable, so a simplification is required.

Given a finite collection of basis functions F={ƒᵢ}ⁿᵢ₌₁, where ƒᵢ: Ω→R, one can construct planar maps by linear combinations of the basis functions,

$$f ( x ) = {( u ( x ) , v ( x ) )}^{T} = {\sum }_{i = 1}^{n} {c}_{i} {f}_{i} ( x ) , \qquad ( 3 )$$

where cᵢ=(cᵢ¹,cᵢ²)^{T}∈R^{2×1} are column vectors. Such a map can be represented by a matrix c=[c₁, c₂, . . . , cₙ]∈R^{2×n} containing the coefficients from eq. (3) as columns.

The bases mentioned above (and others) work very well for interpolating and approximating scalar functions in the plane, due to their regularity, approximation power and simplicity. Yet using this model as-is for building planar maps can, and often does, introduce arbitrary distortions and uncontrolled fold-overs, which renders this framework suboptimal for space warping and deformation. Nevertheless, it is shown how to constrain c in the space R^{2×n} to provide a mechanism for constructing planar deformations with controllable distortion and without fold-overs.

Basis functions. Although the framework in eq. (3) is general, and can be used in theory with any basis function of choice, it is chosen to experiment with three popular function bases: B-Splines, Thin-Plate Splines (TPS), and Gaussians (see Table 1 on the following page). Nevertheless, the tools developed in this invention are general, and can be used to construct injective and distortion-controlled mappings from different bases as well.

Distortion. The distortion of a differentiable map f at a point x is defined to be some measure of how f changes the metric at the vicinity of x. Most distortion measures can be formulated using the Jacobian matrix,

$$Jf ( x ) = ( \begin{matrix}{\partial }_{x} u ( x ) & {\partial }_{y} u ( x ) \\ {\partial }_{x} υ ( x ) & {\partial }_{y} υ ( x )\end{matrix} ) ,$$

of f at point x, and more specifically, its maximal and minimal singular values, denoted by Σ(f;x) and σ(tx), or simply Σ(x) and σ(x) when there is no risk of confusion. These values measure the extent to which the map stretches a local neighborhood near x.

The distortion measure of f is denoted at x by D(f,x)=D(f)=D(Σ(x),σ(x)), where the greater D is, the greater the distortion. When D(x)=1 there is no distortion at all at x. Two common measures of distortion are used: isometric and conformal. Isometric distortion measures the preservation of lengths and can be computed with Dᵢₛₒ(x)=max {Σ(x),1/σ(x)}. When Σ(x)=σ(x)=1, and only then, Dᵢₛₒ (x)=1, which implies that f is close to a rigid motion in the vicinity of x. Conformal distortion, on the other hand, measures the change in angles that is introduced by the map f and can be calculated with D_{conf}(x)=Σ(x)/σ(x). When Σ(x)=σ(x), D_{conf}(x) reaches its lowest possible value of 1. This indicates that, locally, the map behaves like a similarity transformation (rigid motion with an isotropic scale).

Fold-overs. A continuously differential map f is locally infective at a vicinity of a point x if det Jf(x)>0. To guarantee local injectivity, it suffices to ensure that σ(x)>0 for all x∈Ω, and det Jf(x)>0 for a single point x∈Ω (in fact, one point in each connected component of Ω). Indeed, since σ(x)>0, it is known that det Jf(x)≠0, and since det Jf(x) is a continuous function of x, it cannot change sign in a connected region. Global infectivity of a (proper) differential map f:Ω→R² that is locally injective is guaranteed if the domain is simply connected and f, restricted to the boundary, is injective.

Collocation points and the active set method. The present invention's goal is to control the distortion and local injectivity of the map f over the domain Ω. To this end, a set of collocation points [120] are maintained Z={zⱼ}ⱼ₌₁^{m}⊂Ω, explicitly to monitor and control the distortion and injectivity over. That is, it is ensured that

D(zⱼ)≦K,σ(zⱼ)>0 (4)
for all j=1, . . . , m, where K≧1 is a parameter. Given these bounds on the set Z bounds are provided on the distortion and injectivity of f at all points x∈Ω.

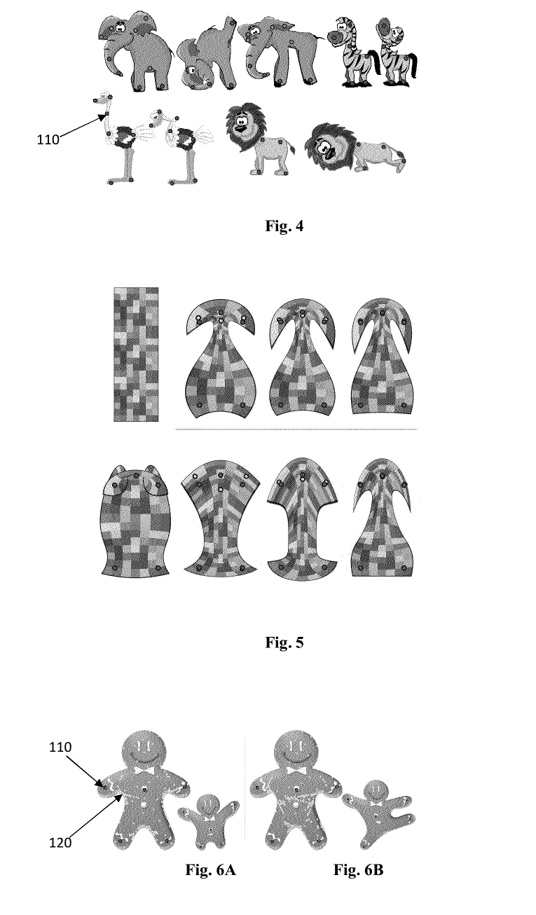

To allow interactive rates, an active set method is used: The constraints are set only on a sparse subset, the active set, Z′⊂Z. Once a certain collocation point z violates the desired bounds in eq. (4), it is added to the active set Z′. Collocation points at which the distortion goes sufficiently below the desired bound are removed from the active set. See FIGS. 3A-3C for an illustration. Implementation details are provided in the optimization method.

It is possible to constrain the distortion at a collocation point z by utilizing the simple observation that the Jacobian matrix off is linear in the variables c,

$$Jf ( x ) = {( ∇ u ( x ) , ∇ v ( x ) )}^{T} = {\sum }_{i = 1}^{n} {c}_{i} ∇ {f}_{i} ( x ) ,$$

and adapting the convexification approach of Lipman 2012 to the meshless setting. Further details are in the optimization method.

The definition of the fill distance h(Z,Ω) of the collocation points in the domain is the furthest distance from Z that can be achieved in Ω, namely,

h(Z,Ω)=max_{x∈Ω}min_{z∈Z}∥x−z∥. (5)

Modulus of Continuity.

One of the key aspects of the present invention is the ability to ensure that the constructed maps via eq. (3) satisfy strict requirements of distortion and injectivity. This is achieved by estimating the change in the singular values functions σ(x),Σ(x) of the Jacobian Jf(x) of the map f. For this, the notion of the modulus of continuity becomes handy: It is a tool for measuring the rate of change of a function. Specifically, a function g:R²→R is said to have a modulus of continuity w, or in short, is ω-continuous, if it satisfies

|g(x)−g(y)|≦ω(∥x−y∥),∀x,y∈Ω, (6)
where ∥χ∥ denotes the Euclidean norm in R², and ω:R⁺→R⁺ is a continuous, strictly monotone function that vanishes at 0. The following explains the computation of the modulus of continuity of the singular values functions σ(x),Σ(x) and describes how to use it for bounding the distortion of the map f. The modulus of continuity of maps (vector valued functions) g:R²→R², is used, where similarly to the scalar case, g is ω-continuous if

∥g(x)−g(y)∥≦ω(∥x−y∥),∀x,y∈Ω. (7)

### Bounding the Distortion

The core of approach of this invention lies in bounding the change in the distortion at a point as it gets further away from a collocation point z∈Z. For many useful function bases F, given the coefficients c and the domain Ω, one can compute a modulus ω=ω_{Σ,σ} such that the singular values functions Σ(x),σ(x) are ω-continuous. This, in turn, allows bounding the change in the singular values.

In one embodiment, this invention provides (i) a general motivation for calculating the modulus ω of singular values; (ii) compute w for the collection of basis functions used herein; (iii) show how w can be used to bound the different distortion measures; and (iv) explore the different strategies for controlling the distortion off over Ω.

Why ω is useful? For example, to bound σ(x) from below at all points x∈Ω it is assumed that the bound δ(z)≧δ>0 at all collocation points z∈Z. Then, if σ(x) is ω-continuous there is |σ(x)−σ(z)|≦ω(∥x−z∥) and therefore in particular σ(x)≧σ(z)−ω(∥ x−z∥)≧δ−ω(∥x−z∥). Similarly, an upper bound to Σ(x) can be found. This is described in the following lemma:

Lemma 1

Let Σ and σ be ω-continuous functions, and let z∈Z be some collocation point. Then for all points x∈Ω,

σ(z)−ω(∥x−z∥)≦σ(x)≦Σ(x)≦Σ(z)+ω(∥x−z∥).

Computing ω for Different F.

Using Lemma 1 requires knowing the modulus of continuity of the singular value functions σ(x),Σ(x) of the map f built using an arbitrary function basis F. Although this task might seem daunting, it is shown that, surprisingly enough, for 2D maps, this problem can be reduced to the easier task of calculating the modulus of continuity of the Jacobian of the map f, or equivalently, the modulus of continuity of the gradients ∇u and ∇v, as the following lemma asserts:

Lemma 2

Let ∇u and ∇v be ω-continuous in Ω. Then both singular values functions Σ and σ are 2ω-continuous.

The proof of this lemma is given in Proof B. This lemma is used to compute a modulus of continuity ω=ω_{Σ,σ} for the singular values functions of a map f defined via eq. (3). First, it is noted that

$$\begin{matrix}‖ ∇ u ( x ) - ∇ u ( y ) ‖ \leq {\sum }_{i = 1}^{n} \vert {c}_{i}^{1} \vert \vert \vert ∇ {f}_{i} ( x ) - ∇ {f}_{i} ( y ) \vert \vert \\ \leq {\sum }_{i = 1}^{n} \vert {c}_{i}^{1} \vert {ω}_{∇ {f}_{i}} ( ‖ x - y ‖ ) \\ \leq ‖ \vert c \vert ‖ {ω}_{∇ F} ( ‖ x - y ‖ ) ,\end{matrix} \qquad ( 8 )$$

where ω_{∇ƒ}_{ᵢ} is a modulus of continuity for the gradient of the basis function ∇ƒᵢ, ω_{∇F} is a modulus function satisfying ω_{∇F}(t)≧ω_{∇ƒ}_{ᵢ}(t), for all t∈R⁺ and all ƒᵢ∈F, and the matrix maximum-norm

$$‖ \vert c \vert ‖ = {max}_{𝓁 ∈ \{ 1 , 2 \}} {\sum }_{i = 1}^{n} \vert {c}_{i}^{𝓁} \vert$$

is used. Equation (8) shows that the modulus of ∇u is ω_{∇u}=|∥c∥|ω_{∇F}. Similar arguments show that ω_{∇v}=|∥d∥|ω_{∇F}. Finally, according to Lemma 2:

ω=2|∥d∥|ω_{∇F}. (9)

In order to use eq. (9) to bound the change in the singular value functions, the modulus of the gradient w_{∇F} for the function basis of interest needs to be known. In Table 1 summarized are the function bases that are used herein, as well as the moduli of their gradients, ω_{∇F}. In Proof A as in the following, the derivations of these modulus functions are provided. Note that the gradient modulus ω_{∇F} of the TPS applies only locally to points x,y∈R² such that ∥x−y∥≦(1.25e)⁻¹≈0.29. However, this is not a significant restriction, as the fill distance is always smaller in practice.

TABLE 1
Function bases and the gradient modulus function

| Basis | fᵢ | ω_{∇F}(t) |
|---|---|---|
| B-Splines | B_{Δ}⁽³⁾(x − xᵢ)B_{Δ}⁽³⁾(y − yᵢ) | $\frac{4}{3 {Δ}^{2}} t$ |
| TPS | $\frac{1}{2} ( {‖ x - {x}_{i} ‖}^{2} ) ln ( {‖ x - {x}_{i} ‖}^{2} )$ | t(5.8 + 5 \|lnt\|) |
| Gaussians | $exp ( - \frac{{‖ x - {x}_{i} ‖}^{2}}{2 {s}^{2}} )$ | $\frac{t}{{s}^{2}}$ |

Bounding Isometric and Conformal Distortion.

It is shown below how Lemma 1 and eq. (9) are used to provide bounds on the isometric and/or conformal distortion, assuming such bounds are enforced at a set of collocation points Z.

It is started with isometric distortion and assumed that at all collocation points z∈Z have Dᵢₛₒ(z)≦K, or equivalently,

$$Σ ( z ) \leq K , σ ( z ) \geq \frac{1}{K} . \qquad ( 10 )$$

Denote for brevity h=h(Z,Ω), the fill distance of Z in Ω. Then by using Lemma 1 all points x∈Ω,

$${D}_{iso} ( x ) \leq max \{ K + ω ( h ) , \frac{1}{{K}^{- 1} - ω ( h )} . \} \qquad ( 11 )$$

This bound holds only when K⁻¹>ω(h), which implies that σ(x)>0, which in turn guarantees the injectivity of the map. Otherwise, Dᵢₛₒ(x) cannot be bounded. To bound the conformal distortion, it is assumed that all the collocation points z∈Z satisfy a conformal distortion bound:

Σ(z)≦Kσ(z),σ(z)≧δ, (12)
where the second constraint, with some constant δ>0, is used to avoid σ(x)=0, which may lead to loss of injectivity. Using Lemma 1 as above, for all x∈Ω,

$${D}_{conf} ( x ) \leq K ( \frac{δ + ω ( h )}{δ - ω ( h )} ) , \\ σ ( x ) \geq δ - ω ( h ) . \qquad ( 11 )$$

where, as in the isometric case, δ>ω(h) is required to hold.

Controlling the Distortion of f.

The bounds in eq. (11) and eqs. (13) relate the distortion of the map f at all points in the domain Ω to the distortion K enforced on the collocation points Z and the fill distance of the collocation points h=h(Z,Ω). Using these relationships one can control the distortion of the map f in one of three strategies:
1. Given Z and the distortion bound K on its points, bound the maximal distortion Kₘₐₓ of f everywhere else in Ω.
2. Given the distortion bound K enforced at the points Z and a desired distortion bound Kₘₐₓ>K everywhere in Ω, calculate the required fill distance h to achieve it.
3. Given Z and a desired distortion bound Kₘₐₓ>1 everywhere in Ω, calculate the distortion bound K that should be enforced on Z.

Strategy 1 is accomplished directly from the bounds (11),(13). For strategy 2 it is required to rearrange these equations: noting that ω⁻¹ also monotonically increases, accordingly

$$\begin{matrix}{h}_{iso} \leq {ω}^{- 1} ( min \{ {K}_{max} - K , \frac{1}{K} - \frac{1}{{K}_{max}} \} ) & ( 14 ) \\ {h}_{conf} \leq {ω}^{- 1} ( δ \frac{{K}_{max} - K}{{K}_{max} + K} ) , & ( 15 )\end{matrix}$$

where hᵢₛₒ and h_{conf} are the required fill distances to achieve isometric or conformal distortion Kₘₐₓ, respectively. Note that the inequality for the conformal distortion in particular implies that h_{conf}<ω⁻¹(δ) and hence by eq. (13) that σ(x)>0.

For strategy 3 the bounds are rearranged as follows,

$$\begin{matrix}{K}_{iso} \leq min \{ {K}_{max} - ω ( h ) , \frac{1}{\frac{1}{{K}_{max}} + ω ( h )} \} & ( 16 ) \\ {K}_{conf} \leq {K}_{max} \frac{δ - ω ( h )}{δ + ω ( h )} , {δ}_{conf} > ω ( h ) & ( 17 )\end{matrix}$$

where Kᵢₛₒ, K_{conf}, and δ_{conf} are the distortion bound at the collocation points required to achieve the global isometric and conformal distortion Kₘₐₓ. Note again, that σ(x)>0 is assured due to the inequality for δ_{conf} in eq. (13).

Non-Convex Domains and Interior Distances.

It is often desirable to consider a non-convex domain Ω, endowed with an interior distance, and basis functions defined using this distance. The definition of the fill-distance and the modulus of continuity are changed accordingly. The analysis above can then be used as-is once the gradient modulus ω_{∇F} is available, similarly to Table 1. The present invention only provides the modulus ω_{∇F} for the Euclidean distance-based basis functions listed in table 1, leaving the analysis of other bases to future work.

It is emphasized that in case the non-convex domain is endowed with the Euclidean distance, the analysis holds as-is for the basis functions from Table 1. This is due to the fact that these basis functions are defined everywhere in R² and the modulus of their gradients is agnostic to the shape of the domain. To generate a set of collocation points with a prescribed Euclidean fill-distance in a non-convex domain it is enough to ask that the domain satisfies the cone condition (see e.g., WendlandError! Reference source not found. 2004 [WENDLAND, H. 2004. Scattered Data Approximation. Cambridge University Press], Definition 3.6), and to consider all the points from a surrounding uniform grid that fall inside the domain.

### Optimization and Implementation Details

This section describes the algorithm for calculating maps of the form of eq. (3), which conform to the positional constraints prescribed by the user, and satisfy distortion and injectivity requirements. This algorithm is summarized in Algorithm 1. The theory in optimization method suggests replacing the optimization problem in (1)-(2) with the following:

$${min}_{c} {E}_{pos} ( f ) + λ {E}_{reg} ( f ) \\ s . t . D ( f ; z ) \leq K , ∀ z ∈ 𝒵 , - \\ f = {\sum }_{i = 1}^{n} {c}_{i} {f}_{i} , \qquad ( 18 )$$

where Eₚₒₛ is the energy of the positional constraints that is changed during user interaction, E_{reg} is a regularization energy, D=Dᵢₛₒ or D=D_{conf} is the distortion type, and K≧1 is a user prescribed distortion bound. According to the optimization method, for the correct choice of K and Z, f is guaranteed to be injective and have distortion smaller than KₘₐₓIn the following, Eq. (18) is formulated as a Second-Order Cone Program (SOCP), which can be solved efficiently by an interior point method.

It is remarked here the positional constrains energy Eₚₒₛ from eq. (18) can be replaced with hard constraints. In this case however, the problem may be infeasible due to the distortion bound, regardless of how the basis functions are chosen. This can occur if, for example, the isometric distortion is required to not exceed a value of K, but two handles are pulled apart by a factor greater than K. In an interactive session, this means that the deformation will not update until the handles are put back in acceptable positions, which can become a nuisance to the user.

Activation of Constraints.

During interaction, eq. (18) is solved constantly as the user manipulates the handles. At each optimization step, only a fraction of the collocation points [120] is active, so removing the rest of the collocation point will not change the result, but will greatly reduce the computation time. In the following, an algorithm is devised that utilizes this fact, where collocation points may be inserted or removed from the active-set before each step.

The algorithm should make the interaction as smooth as possible; the distortion at any deactivated collocation point should not suddenly become significantly greater than K at any given step. Otherwise, at the next step, the point will become active, which will cause the deformation to “jump”. Therefore, it is opted to insert points into the active-set when the distortion on them is slightly below K. It is assumed that the collocation points are sampled on a dense rectangular grid. Before each optimization step, the distortion on each collocation point is measured, and the local maxima of the distortion are found. If a local maximum has a distortion greater than K_{high} for a specified K_{high} ∈[1,K], then that point is added to the active-set for the next optimization step. If any collocation point has distortion lower than K_{low} where K_{low}∈[1,K_{high}], then that point is removed from the active-set. This ensures that the collocation points with the maximal distortion are always active, and hence all other collocation points must have distortion smaller than K. To further stabilize the process against fast movement of the handles by the user, one may keep a small subset of equally spread collocation points always active. In this implementation the default values are used K_{high}=0.1+0.9K and K_{low}=0.5+0.5K. See FIGS. 6A and 6B for examples.

During an interactive session, potentially all of the collocation points can become active at once. However, this does not occur in practice, since only points that are above a threshold and are local maxima of the distortion can be activated. Thus, only a small number of isolated points will be activated at each iteration. The only scenario in which all collocation points are activated simultaneously is when the distortion is constant everywhere when it crosses the distortion bound threshold. This scenario is extremely unlikely due to nature of the deformation energy and the bases functions used.

Distortion and Injectivity Constraints.

The points in the active-set are explicitly constrained according to eq. (10) or (12). This requires constraining the singular values of the Jacobian Jf(z) for all z∈Z. A new formulation is provided to the convex second-order cone constraints described in Lipman 2012 where the singular values of the Jacobian of the map f are expressed in terms of the gradients of f (i.e., ∇u and ∇v), which is compact and useful for proving Lemma 2 (see Proof B).

Two vectors, J_{S}f(x) and J_{A}f(x), are defined corresponding to the similarity and anti-similarity parts of Jf(x), as follows

$${J}_{S} f ( x ) = \frac{∇ u ( x ) + ℐ ∇ υ ( x )}{2} \\ {J}_{A} f ( x ) = \frac{∇ u ( x ) - ℐ ∇ υ ( x )}{2} . \qquad ( 19 )$$

Here I is the counter-clockwise rotation 2×2 matrix by π/2. It can be shown (see e.g. Lehto and Virtanen 1973, ch. 1.9, p. 49) that the singular values of Jf(x) can then be expressed as

Σ(x)=∥J_{S}f(x)∥+∥J_{A}f(x)∥

σ(x)=∥∥J_{S}f(x)∥−∥J_{A}f(x)∥| (20)

The requirement (10) for the isometric distortion can be written in terms of J_{S}f and J_{A}f, which are linear in c. Eq. (10) then becomes

$$\begin{matrix}‖ {J}_{S} f ( {x}_{i} ) ‖ + ‖ {J}_{A} f ( {x}_{i} ) ‖ \leq K & ( 21 ) \\ ‖ {J}_{S} f ( {x}_{i} ) ‖ - ‖ {J}_{A} f ( {x}_{i} ) ‖ \geq \frac{1}{K} , & ( 22 )\end{matrix}$$

where eq. (21) can be transformed into convex cone constraints,

∥J_{S}f(xᵢ)∥≦tᵢ (23a)

∥J_{A}f(xᵢ)∥≦sᵢ (23b)

tᵢ+sᵢ≦K, (23c)
where tᵢ,sᵢ are auxiliary variables. However, trying to apply a similar transformation to eq. (22) will result in the non-convex cone-complement constraint,

∥J_{S}f(xᵢ)∥≧rᵢ, (24)
for an auxiliary rᵢ. Following Lipman's 2012 approach, eq. (24) can be convexified by introducing the notion of frames. A frame is a unit vector d used to replace eq. (24) by

J_{S}f(xᵢ)·dᵢ≧rᵢ. (25)

Eq. (25) is a half plane that is contained in the cone-complement of eq. (24) (FIG. 12A). Using (25), (22) can be replaced with

$${J}_{S} f ( {x}_{i} ) \cdot {d}_{i} - {s}_{i} \geq \frac{1}{K} , \qquad ( 26 )$$

noting that rᵢ is actually redundant. It is also noted that this constraint forces the determinant to be positive.

The optimal choice of dᵢ at a certain optimization step depends on the value of J_{S}f(xᵢ) at the previous step. The boundary of the half plane is defined by dᵢ to be as far away as possible from J_{S}f(xᵢ) of the previous step to allow maximum maneuverability for the next step. This is achieved by setting

dᵢ=J_{S}f(xᵢ)/∥J_{S}f(xᵢ)∥ (27)
after each step. For the conformal distortion case the constraints are written as in Lipman 2012 in the following notation:

$$\begin{matrix}‖ {J}_{A} f ( {x}_{i} ) ‖ \leq \frac{K - 1}{K + 1} {J}_{S} f ( {x}_{i} ) \cdot {d}_{i} & ( 28 a ) \\ ‖ {J}_{A} f ( {x}_{i} ) ‖ \leq {J}_{S} f ( {x}_{i} ) \cdot {d}_{i} - δ . & ( 28 b )\end{matrix}$$

Initialization of the Frames in Lipman 2012, the Frames Had to be Picked Correctly to guarantee feasibility.

However, here, matters are simpler. Firstly, by using soft positional constraints it is ensured that a solution always exists. Although the choice of frames may not be optimal in the first iteration, it will improve in subsequent steps. Secondly, the interaction usually starts from a rest pose, so the trivial solution has the identity as the Jacobian for each collocation point, and hence satisfies any distortion bound. To include the trivial solution in the feasible set it is set that the frames to be dᵢ=(1,0) for all dᵢ.

Deformation energies and positional constraints. The energy Eₚₒₛ(f) for the positional constraints in eq. (18) is defined by

$${E}_{pos} ( f ) = {\sum }_{l} ‖ f ( {p}_{l} ) - {q}_{l} ‖ = {\sum }_{l} ‖ {\sum }_{i = 1}^{n} {c}_{i} {f}_{i} ( {p}_{l} ) - {q}_{l} ‖ \qquad ( 29 )$$

where {pₗ}ₗ₌₁ⁿ^{ₗ} and {qₗ}ₗ₌₁ⁿ^{ₗ} are the source and target positions of the handles. It is chosen to this energy instead of the more common quadratic energy since it is more natural in the SOCP setting, although a quadratic energy can be used as well (by adding another cone constraint). Minimizing this energy is equivalent to minimizing,

$$min {\sum }_{l} {r}_{l} \\ s . t . ‖ {\sum }_{i = 1}^{n} {c}_{i} {f}_{i} ( {p}_{l} ) - {q}_{l} ‖ \leq {r}_{l} , ∀ l \qquad ( 30 )$$

where rₗ are auxiliary variables. Eq. (30) is an SOCP, which can be combined with the distortion constraints of the previous paragraph.

As for the regularization energy E_{reg}, a combination of two common functional is used: the biharmonic energy, E_{bh} and the ARAP energy, Eₐᵣₐₚ. The biharmonic energy is defined by

$${E}_{bh} ( f ) = {E}_{bh} ( u , v ) = \int {\int }_{Ω} {‖ Hu ( x ) ‖}_{F}^{2} + {‖ Hv ( x ) ‖}_{F}^{2} d A , \qquad ( 31 )$$

where Hu and Hv are the Hessians of u and v, respectively, which is a quadratic form in c. Once c is taken out of the integral, the integration can be done by numerical quadrature. The ARAP energy is defined by the standard sum,

$${E}_{arap} ( f ) = {\sum }_{s = 1}^{{n}_{s}} {‖ Jf ( {r}_{s} ) - Q ( {r}_{s} ) ‖}_{F}^{2} , \qquad ( 32 )$$

where {rₛ}ₛ₌₁ⁿ^{ₛ} are a set of equally spread pre-defined points, and Q(rₛ) is the closest rotation matrix to Jf(rₛ). Due to the non-convexity of eq. (32), incorporating it in an optimization problem usually requires a local-global approach in order to solve it (see Liu et al. 2008 [LIU, L., ZHANG, L., XU, Y., GOTSMAN, C., AND GORTLER, S. J. 2008. A local/global approach to mesh parameterization. Proc. Eurographics Symposium on Geometry Processing 27, 5, 1495-1504]). Using the frames, it can be seen that eq. (32) can be solved via the quadratic functional,

$${E}_{arap} ( f ) = {\sum }_{s = 1}^{{n}_{s}} ( {‖ {J}_{A} f ( x ) ‖}_{F}^{2} + {‖ {J}_{S} f ( x ) - {d}_{s} ‖}_{F}^{2} ) \qquad ( 33 )$$

where dₛ is the frame at rₛ.

Algorithm 1: Provably good planar mapping

```
Input:
  Set of positional constraints {pₗ}ₗ₌₁ⁿₗ and {qₗ}ₗ₌₁ⁿₗ
  Set of basis functions fᵢ ∈ [symbol]
  Grid of collocation points [symbol]   = {zⱼ}ⱼ₌₁^{m}
  Distortion type and bound on collocation points K ≧ 1
Output:
  Deformation f
Initialization:
if first step then
  | Precompute fᵢ(z) and ∇ fᵢ(z) for all z ∈ [symbol]  .
  | Set dᵢ = (1, 0) for all dᵢ.
  | Initialize empty active set [symbol]  ′.
  |_ Initialize set [symbol]  ″ with farthest point samples.
Evaluate D(z) for z ∈ [symbol]  .
Find the set [symbol]  ₘₐₓ of local maxima of D(z)
foreach z ∈ [symbol]  ₘₐₓ such that D(z) > K_{high} do
  |_ insert z to [symbol]  ′
foreach z ∈ [symbol]   such that D(z) < K_{low} do
  |_ Remove z from [symbol]  ′
Optimization:
Solve the problem in (18) using the SOCP formulation to find c.
Use the constraints from eq. (23) and eq. (26) for the isometric
case, and those of eq. (28) in the conformal case on the collocation
points in [symbol]  ′ ∪ [symbol]  ″ . Use energies from eq. (30), (31), and/or (33).
Postprocessing:
Compute f using c and [symbol]  .
Update dᵢ using eq. (27).
Return:
  Deformation f
```

### Results

Software Implementation and Timing.

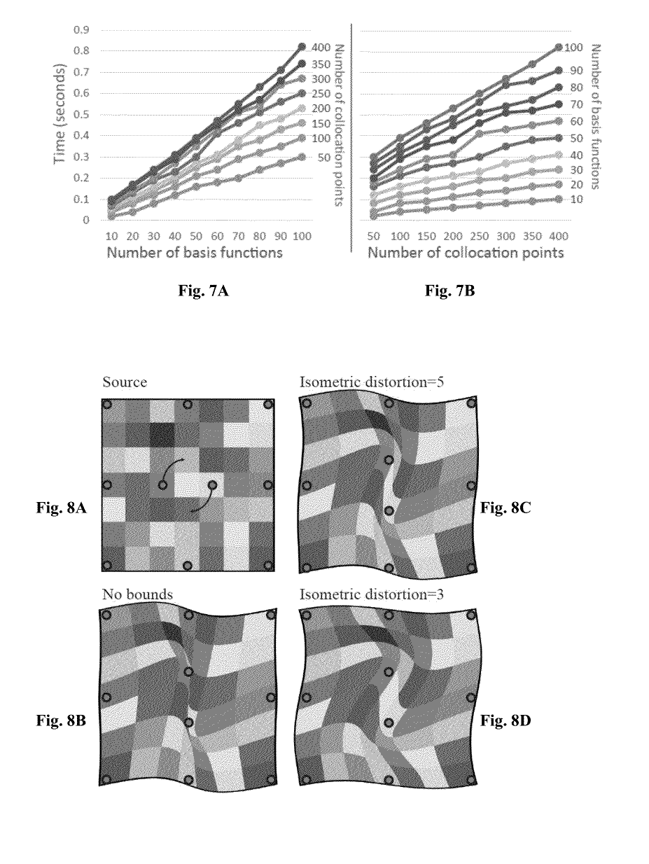

The present invention implemented interactive software using Algorithm 1 and used Mosek for solving the optimization problem, and Matlab for updating the active-set. In addition, an external OpenGL application is used to interact and show the deformation. A machine with Intel i7 CPU clocked at 3.5 GHz is used. The included video shows an interactive session using this software. FIGS. 7A and 7B show timings for solving the optimization problem using Mosek as a function of the number of basis functions (FIG. 7B) and the size of the active-set (FIG. 7B). For this range, which covers the results herein, the time complexity exhibits linear behaviour. In all of the experiments a 200² grid of collocation points during interaction is used, and after being satisfied with the results it is switched to higher grid resolutions using Strategy 2 to guarantee the bounds on the distortion.

Parameters and function bases. The present approach is quite versatile as the different function bases, and the distortion type and bound already attain a large variety of different results. A set of examples is presented that are assumed to advocate the use of the present approach.

FIG. 5 presents an example of a deformation of a bar using a 6 by 6 tensor product of uniform cubic B-Splines using the energy E_{reg}=Eₚₒₛ+10⁻²Eₐᵣₐₚ. Note that for the lower values of K, the positional constraints cannot be satisfied. Also note that with no distortion constraints, the deformation creates two singularities, which were unintended and undesired. Using strategy 3 it is found that in order to achieve injectivity for all cases, it was enough to check the distortion on a grid of size 3000². For this grid it is found that for K=2, 3, 4, the maximal distortion was guaranteed to be smaller than 3.2, 10 and 49 in the isometric case respectively, and 14, 35 and 33 in the conformal case.

FIGS. 8A-8D present additional examples of deformations of a square to demonstrate the effectiveness of the present method for warping. Using TPS this time, with 25 bases positioned on a grid, two points are rotated in the middle while keeping some points on the boundary fixed. The smoothness energy Eₚₒₛ+10⁻¹E_{bh} was used. In this case, the unconstrained map resulted in a fold-over that made the sub-square in the middle completely disappear, while the constrained maps stayed bijective. The required grid size that provides the injectivity certification for K=5 in this example was slightly less than 6000². For this resolution, the computation shows that for K=3, the maximal distortion everywhere is smaller than 7.

Mesh-Based Vs. Meshless.

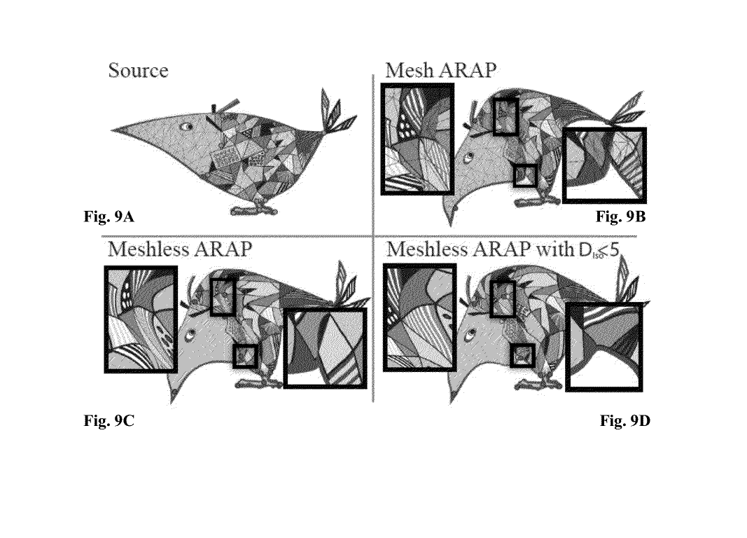

The presented results are compared with the results of previous similar mesh-based methods. FIGS. 9A-9D present a bird image deformed with a variant of the ARAP method of Igarashi et al. 2005 [IGARASHI, T., MOSCOVICH, T., AND HUGHES, J. F. 2005. As-rigid-as-possible shape manipulation. ACM Trans. Graph. 24, 3 (July), 1134-1141] as implemented in Adobe Photoshop. This result is compared to the meshless approach using ARAP energy with and without the distortion constraints. One of the main difficulties with mesh-based ARAP, which can be seen in FIG. 9B, is that when the object is forced to undergo a deformation that is not close to being locally rigid, cusps with fold-overs appear near the handles. This cannot happen when the basis functions are smooth, but even then the ARAP functional creates fold-overs and unbounded distortion. This is rectified by incorporating the distortion constraints. In this example, the required grid size to ensure injectivity was also 6000².

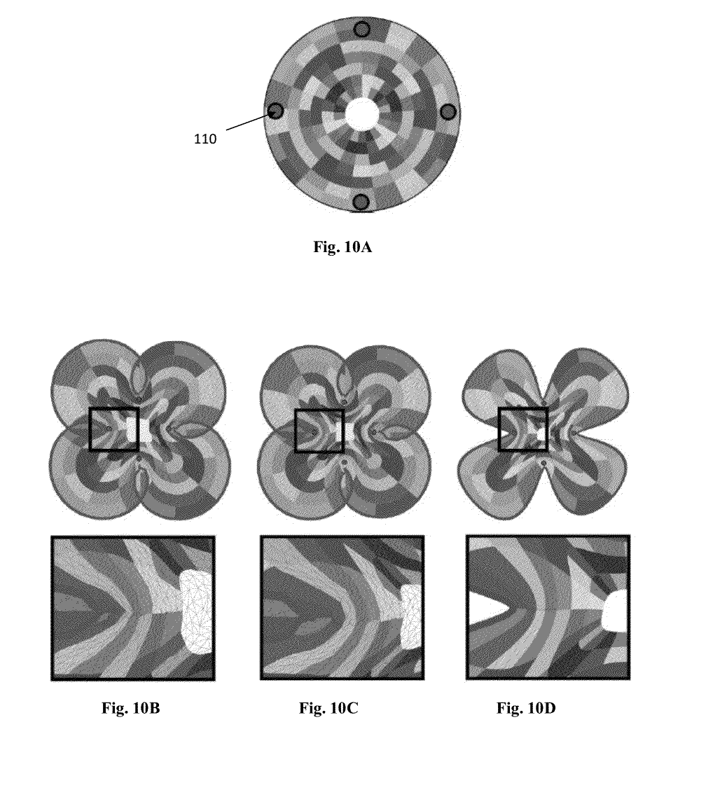

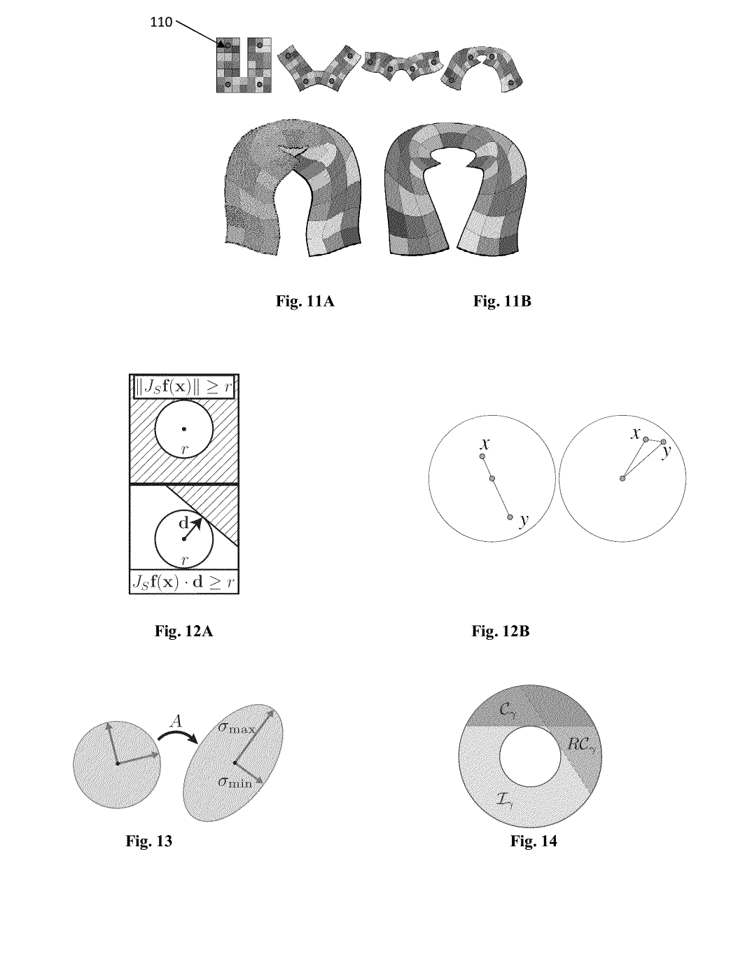

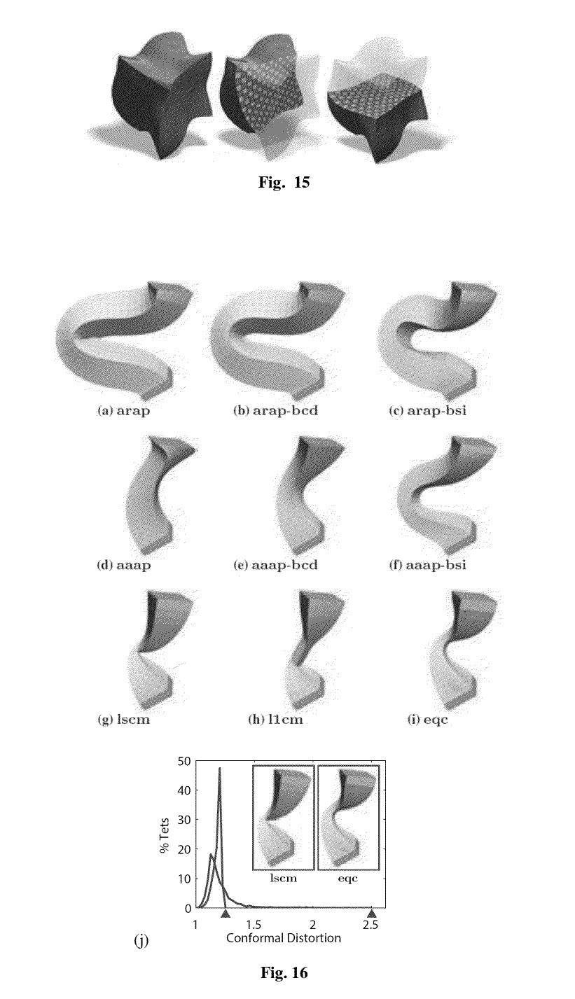

FIGS. 10A-10D demonstrate a deformation of a disk (FIG. 10A) using the method of Schüller et al. 2013 (FIG. 10B) and Lipman 2012 (FIG. 10C) and compare it to the present invention (FIG. 10D) using Dᵢₛₒ=5. Both mesh-based methods guarantee injectivity, as the present method does, but it is clearly seen they lack smoothness, in contrast to the present approach. In this example, a grid of 2000² collocation points proves the map is injective. By evaluating the distortion on 4000² points it is shown that the maximal isometric distortion is smaller than 10.

Shape Aware Bases.

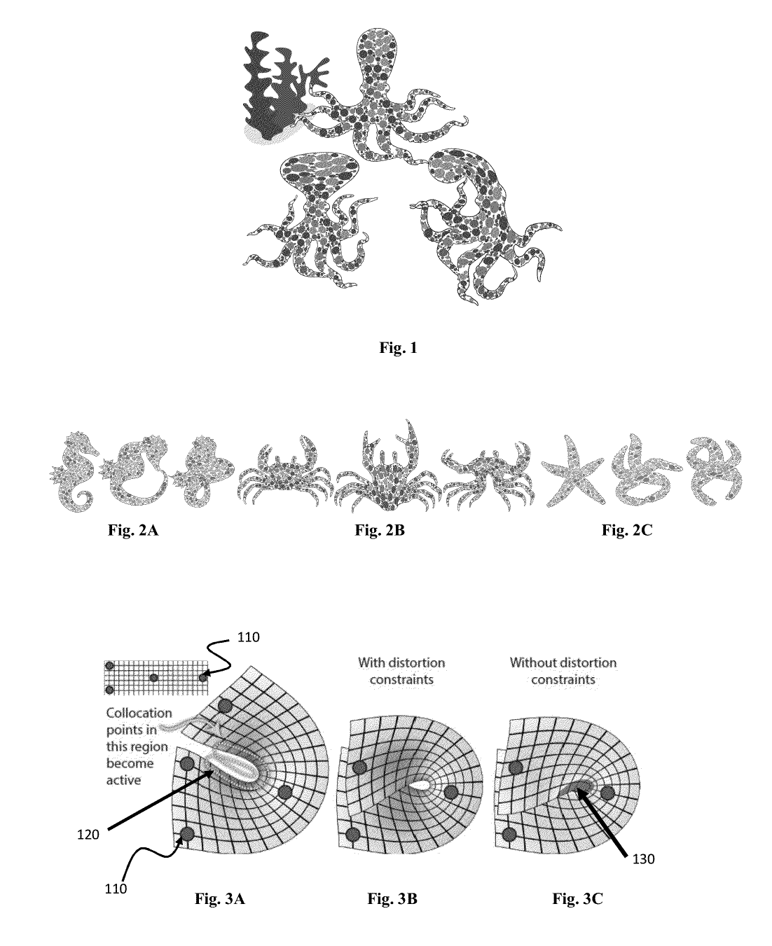

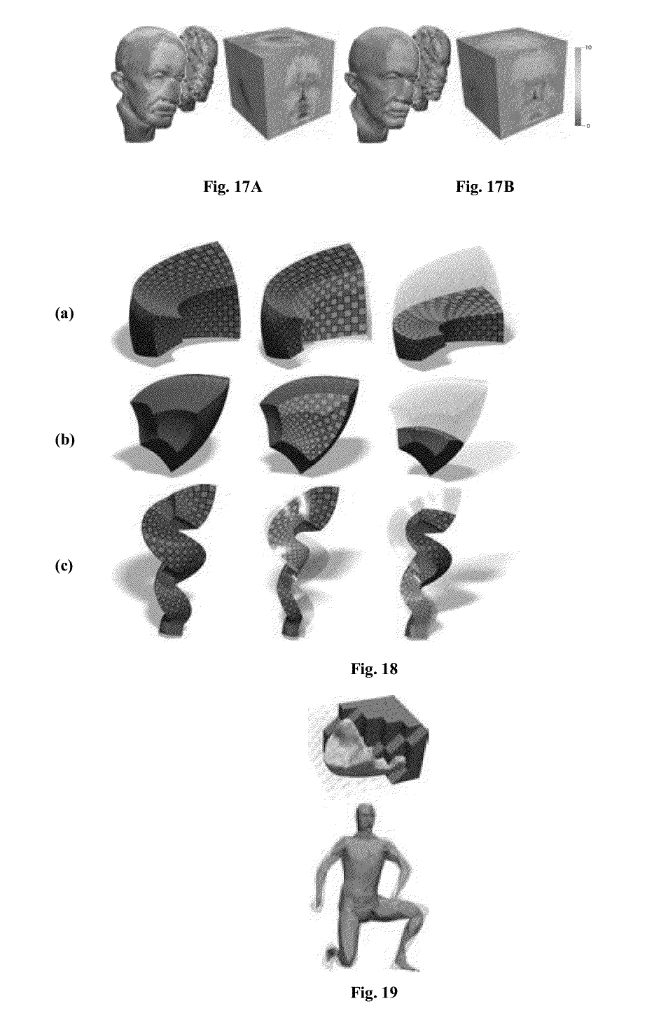

The previous results show deformations using the Euclidean distance-based function bases provided in Table 1. For non-convex domains endowed with an internal distance, it is better to use bases that are shape aware, namely, their influence obeys internal distances. Many possibilities exist in the literature, e.g., the shape function or any smooth set of generalized barycentric coordinates. In the presented experiments shape aware variation of Gaussians are tested, which is achieved by simply replacing the norm in their definition with the shortest distance function. FIGS. 11A-11B show such a deformation FIG. 11B and compare it again to Schüller et al. 2013 (FIG. 11A). Although their method does not allow fold-overs to occur, cusps can still be seen where the handles are. FIGS. 1, 2A-2C, and 4 also demonstrate deformations with this basis function. To provide a proof of injectivity and/or bounded distortion for these examples the modulus of the gradients of the Gaussian shape-aware functions, ω_{∇F}, should be calculated. Further it is noted that the deformations are as smooth as the basis functions. Using exact shortest distances (which is done here for simplicity) in a non-convex polygonal domain will have discontinuous derivatives at certain points in the domain, but nevertheless produce visually pleasing results.

The present invention presents a framework for making general smooth basis functions suitable for planar deformations. The framework is demonstrated with three popular function bases and the algorithm is shown to allow interactive deformations. The present invention provides theory that allows establishing guarantees of injectivity and bounds of isometric and/or conformal distortion.

The presented theory and bounds rely on the simple expressions of the singular values of the Jacobian. These expressions are true only in the case of two dimensional domains, and therefore the presented method is not trivially extended to three dimensions. However, this is the only missing requirement for the transition into higher dimensions, since other key ingredients, such as the use of collocation points and active set remains the same. If this gap can be bridged, it is assumed that smooth maps with controlled distortion can also be generated in 3D using the present approach.

One limitation of the convexification approach occurs when enforcing hard positional constraints: if the problem is reported as infeasible in this case, one cannot tell whether this is due to the non-convex problem being infeasible or to the frames not being chosen correctly. This limitation is alleviated either by using soft positional constrains as explained herein, or by looking for appropriate frames using some other method (e.g., taking the global unconstrained minimum of the functional and extracting frames from it). In any case the question of feasibility when hard constraints are used is still an open problem.

While the map computation is done interactively, proving its injectivity and bounding its distortion may require a more time, especially if the bounds are strict and/or the deformation is strong. This is due to the very dense grids required by the theoretical bounds. Although the task is simple—all that is required is evaluate the distortion on every point of the grid—the current serial implementation allows supporting this computation interactively only on medium sized grids (40k points). However, it is assumed that using GPU to evaluate the distortion on the collocation points in parallel may enable interactive rates for large grids.

The presented results show that, by using a generic SOCP solver (Mosek), the present invention's approach can handle a few hundreds of active collocation points and basis function at interactive rates. However, there may be situations where thousands or more are required. Developing a specialized solver for this task can allow such large problems to be solved quickly.

8 Preliminaries and problem statement for controlling the singular values of n-dimensional matrices is often required in geometric algorithms in graphics and engineering.

Definitions and Notations.

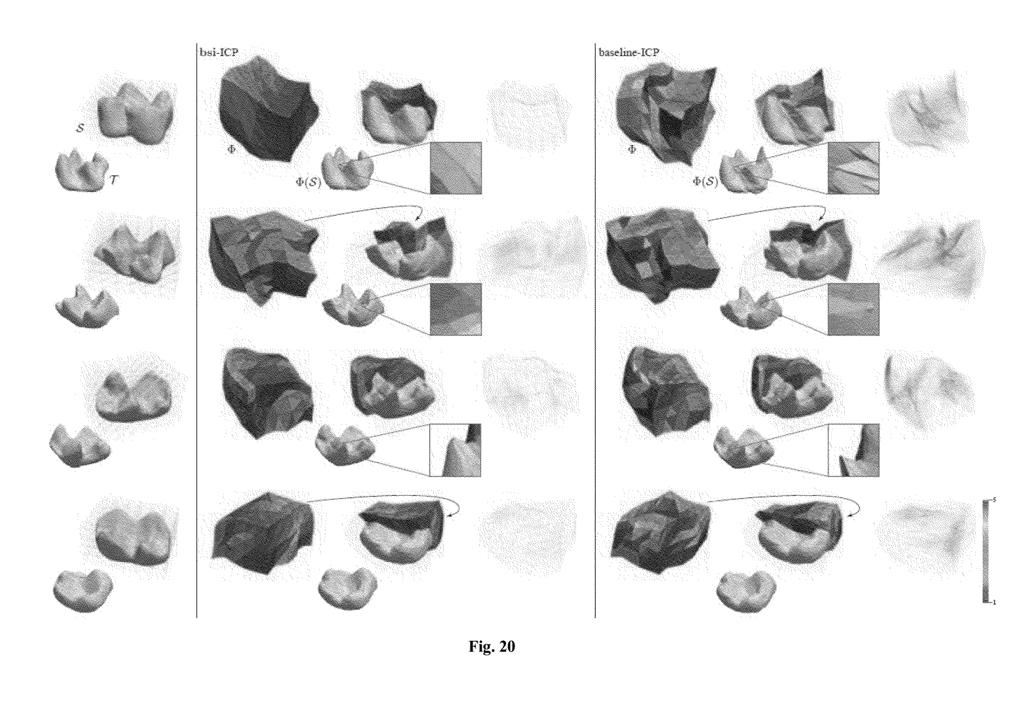

Let A∈R^{n×n}, and denote by σ₁(A)≧σ₂(A)≧ . . . ≧σ(A) its singular values. Also used is the notation σₘₐₓΔσ₁ and σₘᵢₙΔσₙ. Geometrically, σₘₐₓ(A) and σₘₐₓ(A) quantify, respectively, the largest and smallest change of Euclidean length induced by applying A to any vector (FIG. 13). it is said that a matrix A is orientation preserving if it satisfies det(A)≧0. The notation A≧0 is used to imply that A is a symmetric, positive semidefinite (PSD) matrix. Such an expression is called a linear matrix inequality (LMI) Boyd and Vandenberghe 2004 [BOYD, S., AND VANDENBERGHE, L. 2004. Convex Optimization. Cambridge University Press, New York, N.Y., USA]. In the same manner, A≧B implies that A−B is PSD and thus for a scalar c∈R, the equation S≧cI implies that the eigenvalues of S are larger or equal to c. A semidefinite program (SDP) is a convex optimization problem formulated with LMI constraints and a linear objective. It is noted that any linear program, convex quadratic program and second-order cone program can be formulated as an SDP.

Goal and Approach.

The goal of the present invention is to characterize and provide an efficient algorithm for optimizing a class of problems formulated in terms of the minimal and maximal singular values of n×n matrices.

For example, consider the following toy problem:

$$\begin{matrix}{min}_{A ∈ {R}^{n \times n}} f ( A ) & ( 41 a ) \\ s . t . {σ}_{min} ( A ) \geq {Γ}^{- 1} & ( 41 b ) \\ {σ}_{max} ( A ) \leq Γ & ( 41 c ) \\ det ( A ) \geq 0 , & ( 41 d )\end{matrix}$$

for some constant Γ≧1. Intuitively, this problem describes the minimization of the functional f (A) under the constraint that the matrix A deviates by at most F from being a rotation. This is a non-convex problem even when f is convex, and we are unaware of any efficient algorithms for optimizing it in the general n-dimensional case.

The goal of the present invention is to present an algorithm for solving problems such as the one described above. More generally, a broader class of problems is considered in the form of the following meta-problem:

$$\begin{matrix}{min}_{A ∈ {R}^{n \times n}} f ( A , {σ}_{min} ( A ) , {σ}_{max} ( A ) ) & ( 42 a ) \\ s . t . {g}_{i} ( A , {σ}_{min} ( A ) , {σ}_{max} ( A ) ) \leq 0 , i = 1 , … , r & ( 42 b ) \\ det ( A ) \geq 0 , & ( 42 c )\end{matrix}$$

where f(A, x, y), gᵢ(A, x, y) are convex functions that satisfy certain monotonicity conditions in x, y (as detailed in Optimization of the meta-problem), and eq. (42c) ensures that A is orientation preserving.

Note that problem (41) readily fits this framework with f(A, x, y)=f(A), gᵢ(A, x, y)=x+Γ⁻¹, and g₂(A, x, y)=y−Γ.

In the present invention a generic iterative algorithm for solving instantiations of the meta-problem is presented. In a nutshell, each iteration of the algorithm solves a semidefinite program (SDP). The algorithm is shown to be monotonically decreasing and optimal in the sense that each iteration considers the “largest” convex sub-problem of the non-convex meta-problem.

Several interesting applications are demonstrated in geometry processing and computer graphics that can be formulated in terms of singular values of matrices, and claim that it is expected to find other applications in the fields of computer graphics and vision.

### Bounding Singular Values Using LMI's

The key to successful optimization of the meta-problem (42) is understanding how to bound the maximal singular value of a matrix from above, and the minimal singular value from below. To that end, let us define two subsets of n×n matrices: first, the set of all matrices whose maximal singular value is at most a constant Γ,

I^{Γ}={A∈R^{n×n}|σₘₐₓ(A)≦σ}. (43)

Second, the subset of orientation-preserving matrices whose smallest singular value is at least a constant γ≧0,

I_{γ}={A∈R^{n×n}|σₘᵢₙ(A)≧γ,det(A)≦0}. (44)

Working with I^{Γ},I_{γ}, as defined above, is not straightforward. These sets are characterized in terms of roots of high-order polynomials; namely, the characteristic polynomial of A^{T}A and the determinant of A. As such, one cannot directly employ these definitions in an optimization framework.

As is shown next, the set I^{Γ} is a convex set in R^{n×n} and can be precisely reformulated as an LMI. In contrast, however, I_{γ} is not convex and introduces a challenge. Nonetheless, it is shown that it is possible to characterize its maximal convex subsets using a surprisingly simple LMI.

Bounding σₘₐₓ from Above

The constraint σₘₐₓ(A)≦Γ can be readily written as a convex LMI (Boyd and Vandenberghe 2004, Section 4.6.3). The formulation below is summarized. Let

$${C}^{Γ} = \{ A ∈ {R}^{n \times n} : ( \begin{matrix}Γ I & A \\ {A}^{T} & Γ I \\ & \end{matrix} ) \geq 0 \} . \qquad ( 45 )$$

Then, A∈C^{σ} [symbol] A^{T}A≦Γ²I [symbol] σₘₐₓ(A)≦F, where the first equivalence is an immediate consequence of Schur's complement. It is therefore concluded that C^{Γ}=I^{Γ}.

Bounding σₘᵢₙ from Below

The space I_{γ}, defined by the constraints σₘᵢₙ(A)≧γ and det(A)≧0, is non-convex and thus more challenging. A common approach for dealing with non-convex sets is to replace them with convex sets that contain them (e.g., their convex hulls). In this case, such a type of convexification will include matrices whose minimal singular values are not properly bounded, thus significantly deviating from the present set of interest. Instead, it is suggested to work with convex sets contained in I_{γ}. Specifically, introduce is a family of maximal subsets of I_{γ}, which furthermore covers the entire space I_{γ}. This allows us to devise effective optimization procedures and guarantees that the constraints of the problem are satisfied.

The present invention's basic formula for characterizing the maximal convex subsets of I_{γ} is as simple as

$$\frac{A + {A}^{T}}{2} \geq γ I . \qquad ( 46 )$$

For an arbitrary γ≧0 it is defined

$${C}_{γ} = ( A ∈ {R}^{n \times n} \vert \frac{A + {A}^{T}}{2} \geq γ I \} . \qquad ( 47 )$$

C_{γ} is defined in terms of an LMI, and so it is readily convex and can be directly used in SDP optimization. The optimization framework relies on the next observations: C_{γ} is indeed a convex subset of I_{γ}, and
1. C_{γ} is large. It is of full dimension, extending the set of symmetric matrices with bounded eigenvalues.
2. Furthermore, it is maximal in I₇ and can be used to generate a family of maximal convex subsets that cover it.

These properties suggest that C_{γ} is a good choice for the present invention's optimization framework. In fact, it is an optimal choice in the convex regime. Next, the properties of this set are elaborated. To that end, it is first observed that C, admits two alternative representations that help shed light on its properties,

C_{γ}={A|x^{T}Ax≧γ, for all ∥x∥₂=1,x∈Rⁿ}, (48)

and

C_{γ}={SIS≦γI}⊕{E|E=E^{T}}, (49)
where ⊕ denotes the (internal) direct sum operator. In other words, C_{γ} is the set of matrices whose symmetric part is PSD with eigenvalues no less than γ, and an arbitrary antisymmetric part. The equivalency between (49) and (49) is immediate, by noticing that the decomposition A=S+E is unique and that x^{T} Ex=0. To see the equivalency to (47), let A=S+E as in (49); clearly, A satisfies the condition of (47) as A+A^{T}=2S. Conversely, if A satisfies (47), then by definition of PSD matrices x^{T} (A+A^{T})x≧2γ, which implies that A satisfies the condition of (48). Main results are accordingly stated:

Theorem 1

C_{γ} is a convex subset of I_{γ}.
Proof. As previously mentioned, C_{γ} is convex as it is expressed in terms of an LMI. To prove it is a subset of I₂, it is required to show that if A∈C_{γ} then σₘᵢₙ(A)≧γ and det(A)≧0.
First, notice that if x is the (unit norm) singular vector of A corresponding to its minimal singular value, then

$${σ}_{min} ( A ) = {‖ Ax ‖}_{2} = {‖ x ‖}_{2} {‖ Ax ‖}_{2} {\geq }^{( CS )} 〈 x , Ax 〉 = {x}^{T} Ax {\geq }^{( 8 )} γ$$

where the inequality labeled by (CS) is due to the Cauchy-Schwartz inequality.

To see that det(A)≧0, recall that it is the product of the eigenvalues λᵢ of A. λᵢ cannot be real and negative, or else it does not satisfy (48) as x^{T}Ax<0≦γ for the corresponding eigenvector. Therefore, all the eigenvalues of A are either non-negative or complex, in which case they come in conjugate pairs, and so their product must be non-negative.

Having established that C_{γ} is a convex subset of I_{γ}, it is required to understand how large this set is. Definition (49) gives two immediate insights to this question: (i) C_{γ} is a set of full dimension, i.e. it has n² degrees of freedom, as the space of n×n matrices itself; (ii) it contains all n×n symmetric matrices with eigenvalues larger or equal to γ. Furthermore, it can be readily shown that C_{γ} contains all n×n rotation matrices with in-plane rotation angles θ₁, . . . , θₖ satisfying |θ|≧cos⁻¹(γ).

This suggests that C_{γ} is “rather large”. Consequently, the question arises, whether it is the “largest” convex subset of I_{γ}, in some sense. If the answer is no, it hypothetically means that one could optimize over larger pieces of I_{γ} and stay within the convex optimization regime. This will leave something to be desired. However, perhaps somewhat surprisingly, the answer is affirmative. As the following theorem shows (proven in the Proof C), C_{γ} is a maximal convex subset of I_{γ}, meaning it cannot be added any other matrix from I_{γ} and stay convex.

Theorem 2

C_{γ} is a maximal convex subset of I_{γ}. That is, if another convex set D⊂I_{γ} satisfies C_{γ}⊂D, then C_{γ}=D.

Orientation Preserving Matrices.

Spaces of orientation preserving matrices are important in graphics, for example, in deformation and meshing applications. Theorems 1 and 2 show that the convex space C_{γ} contains only orientation preserving matrices. Furthermore, they imply that C₀, for γ=0, is a maximal convex subset of the set of orientation preserving matrices, {A|det(A)≧0}.

Covering I_{γ}.

The subset C_{γ} by itself does not cover the entire space I_{γ}. However, rotated copies of C_{γ} can be used to cover I_{γ}, in a natural manner, as the FIG. 14 intuitively illustrates. The rotated copies of C_{γ} are completely equivalent to the original (unrotated) version C_{γ} except they cover different maximal pieces of the space I_{γ}. The construction is simple: take an arbitrary A∈I_{γ}, and let A=RS be its polar decomposition (polar decomposition A=RS means R∈SO(n) and S=S^{T}.). Since A∈I_{γ}, it is necessarily that R is a rotation and S≧γI. Definition (49) implies that S∈C_{γ}. Hence, A∈RC_{γ}, where it is denoted RC_{γ}={RX|X∈C_{γ}}. Since rotations preserve singular values and determinants, RC_{γ}⊂I_{γ}. Furthermore, RC_{γ} is also a maximal convex subset of I_{γ}, for any rotation R. It is therefore defined that a covering of I_{γ} via the family of its convex maximal subsets RC_{γ}:

$${I}_{γ} = {⋃}_{R ∈ SO ( n )} {RC}_{γ} ,$$

where SO(n) denotes the n×n rotation matrices.

Choosing the Rotation of C_{γ}.

For a given optimization problem formulated with I_{γ}, the choice of R determines over which convex piece RC_{γ}⊂I_{γ}, the optimization will be performed. Aiming to optimize a given convex functional over I_{γ}, and assuming an initial guess A∈I_{γ}. An optimization is carried out in some neighbourhood of A contained in I_{γ}. There are infinitely many choices of R∈SO(n) such that RC_{γ} contains such a neighbourhood, and one would like to choose the “best” one in some sense. A sensible choice would be to choose R such that RC_{γ} is symmetric with respect to A; i.e, such that if a rotation of A is in the convex space, so is its inverse rotation. The next lemma shows that choosing R to be the rotation term of the polar decomposition of A (as discussed in the previous paragraph) satisfies exactly this property:

Lemma 3

Let A∈I_{γ}, with polar decomposition A=RS. Then a rotation matrix Q∈SO(n) satisfies QA∈RC_{γ} if and only if Q^{T}A∈RC_{γ}.

This Lemma 3 is proven in Proof C. Therefore, given an “initial guess” A, we shall choose RC_{γ} where R is extracted from the polar decomposition of A.

### Optimization of the Meta-Problem

It is now required to formulate the present algorithm for optimization of the meta-problem (42) presented previously. First, it is required to complete the definition of the meta-problem by specifying the so-called monotonicity conditions,

Definition 1.

A function f(A, x, y): R^{n×n}×R_{≦}²→R is said to satisfy the monotonicity condition if it is monotonically decreasing in variable x and monotonically increasing in variable y, where R_{≦}²={(x, y)|0≦x≦y}.

The invention's meta-problem was defined in (42) along with the requirement that f,gᵢ are convex functions and satisfy the monotonicity conditions. The motivation behind the monotonicity condition is that it precisely characterizes the problems that allow an equivalent formulation in terms of the spaces I_{γ}, I^{Γ} as follows

min f(A,γ,Γ) (50a)

s.t. gᵢ(A,γ,Γ)≦0,i=1, . . . ,r (50b)

A∈I^{Γ} (50c)

A∈I_{γ} (50d)

The equivalence of this problem to the meta-problem (42) is proved in the Proof C.

Eq. (50c) is a convex constraint as explained in Bounding sigma max from above and can be equivalently replaced with the LMI A∈C^{Γ}. Eq. (50d) is the only non-convex part in the formulation above and can be treated as detailed in Bounding sigma min from below by an LMI of the form AδRC_{γ}; the rotation R determines which maximal convex subset of I_{γ} to be used. This leads to the following convex problem:

min f(A,γ,Γ) (51a)

s.t. gᵢ(A,γ,Γ)≧0,i=1, . . . ,r (51b)

A∈C^{Γ} (51c)

A∈RC_{γ}. (51d)

As described in Bounding sigma min from below, we initialize R=R⁽⁰⁾ from an initial guess A⁽⁰⁾ by looking at its polar decomposition A⁽⁰⁾=R⁽⁰⁾S⁽⁰⁾. After solving the convex problem R is reset according to the polar decomposition of the minimizer A and re-optimize. In each iteration of the algorithm the maximal convex set RC_{γ} is chosen to be symmetric w.r.t. the last result. The algorithm is outlined in Algorithm 2.

Algorithn 2: Optimization of the meta-problem

```
Input: Convex functions f, gᵢ as in eq. (2)
      Initial guess A⁽⁰⁾
Output: Minimizer (local) A
A⁽¹⁾ = ∞ · 11^{T} ; // matrix with all entries ∞
n = 0 ;
while ||A⁽ⁿ⁺¹⁾ − A⁽ⁿ⁾||_{F} > ε do
  | Compute the polar decomposition A⁽ⁿ⁾ = R⁽ⁿ⁾S⁽ⁿ⁾;
  | Solve SDP (11) with R = R⁽ⁿ⁾;
  | Set A⁽ⁿ⁺¹⁾ to be the minimizer;
  |_ n = n + 1 ;
return A = A⁽ⁿ⁺¹⁾;
```

Although Algorithm 2 is not guaranteed to find a global minimum of the (generally non-convex) meta-problem (42), the maximality of the convex spaces RC_{γ} assures that, in each iteration of the algorithm, it is considered that the largest possible part of the non-convex set of n×n matrices is defined by Eq. (50d). This gives the algorithm the best chance of avoiding local minima while restricting the solution to the feasible set of the original meta-problem. Another benefit is that it allows the algorithm to take big steps toward convergence and in practice this algorithm usually requires about 10-20 iterations to converge.

Lastly, it is noted that Algorithm 2 is guaranteed to monotonically decrease the functional value in each iteration since (as discussed in Bounding sigma min from below) the set RC_{γ} is guaranteed to contain A if its polar decomposition is A=RS. Hence, in the notation of Algorithm 2 the previous solution A⁽ⁿ⁻¹⁾ is always feasible in the n'th iteration.

Note that Algorithm 2 requires the SDP (51) to be feasible for the rotation R⁽⁰⁾, extracted from) A⁽⁰⁾. This is a limitation of the algorithm, however in many practical cases a feasible initial rotation is either available or can be computed by solving a feasibility problem using the same algorithm (e.g., in the spirit of phase I methods, Boyd and Vandenberghe 2004, Section 11.4).

### Meta-Problem for a Collection of Matrices

The applications presented in the next section require optimizing the meta-problem over a collection of matrices A₁, . . . , Aⱼ rather than just a single matrix. This requires generalizing the meta-problem (42) and its optimization algorithm (Algorithm 2) to this setup. This generalization is rather straightforward and is explained in this section.

For the multiple-matrix meta-problem Aₗ, . . . , Aₘ∈R^{n×n} f,gᵢ are defined to include all matrices and their maximal and minimal singular values as arguments:

f(,Aⱼ,σₘᵢₙ(Aⱼ),σₘₐₓ(Aⱼ),),
and similarly for gᵢ. As with the single matrix meta-problem, f,gᵢ are required to be convex functions that satisfy the monotonicity condition for each pair σₘᵢₙ(Aⱼ),σₘₐₓ(Aⱼ). The convex formulation (51) now takes the form:

min f( . . . Aⱼ,γⱼ,Γⱼ . . . ) (52a)

s.t. gᵢ( . . . Aⱼ,γⱼ,Γⱼ . . . )≦0,i=1, . . . ,r (52b)

Aⱼ∈C^{Γ}^{ⱼ},j=1, . . . ,m (52c)

Aⱼ∈RⱼC_{γ}_{ⱼ},j=1, . . . ,m (52d)

where Rⱼ are the rotations that define the maximal convex spaces used for each matrix Aⱼ. Algorithm 3 provides a straightforward adaptation of Algorithm 2 to the multi-matrix case. Similarly to Algorithm 2, Algorithm 3 also requires feasible initial rotations Rⱼ.

Algorithm 3: Optimization of the multi-matrix meta-problem

```
Input: Convex functions f, gᵢ
      Initial guess {Aⱼ⁽⁰⁾}ⱼ₌₁^{m}
Output: Minimizer (local) {Aⱼ}ⱼ₌₁^{m}
Aⱼ⁽¹⁾ = ∞ · 11^{T} , j = 1..m;
n = 0 ;
while maxⱼ ||Aⱼ⁽ⁿ⁺¹⁾ − Aⱼ⁽ⁿ⁾||_{F} > ε do
  | Compute the polar decompositions Aⱼ⁽ⁿ⁾ = Rⱼ⁽ⁿ⁾Sⱼ⁽ⁿ⁾;
  | Solve SDP (12) with Rⱼ = Rⱼ⁽ⁿ⁾;
  | Set {Aⱼ⁽ⁿ⁺¹⁾}ⱼ₌₁^{m} to be the minimizer;
  |_ n = n + 1 ;
return {Aⱼ⁽ⁿ⁺¹⁾}ⱼ₌₁^{m};
```

### Applications

In this section the present invention's framework is applied to several problems in geometry processing and uses Algorithms 2, 3 for their optimization. It is shown that for many applications this approach achieves favorable or comparable results to the state-of-art.

### Simplicial Maps of Meshes

Several of the applications were explored optimized and constrained simplicial maps of 3-dimensional meshes. Few definitions were first set and then it is shown how different functionals and constraints of interest in geometry processing can be formulated and optimized in the present invention's framework.

Notations.

It is considered that simplicial maps of 3-dimensional meshes M=(V, T), where V=[v₁, v₂, . . . , vₙ]∈R^{3×n} is a matrix whose columns are the vertices, and F={tⱼ}ⱼ₌₁^{m} is the set of tetrahedra (tets). It is denoted that by |tⱼ| the normalized volume of the j'th tet (so that Σ|tⱼ|=1). A simplicial map Φ:M→R³ is a continuous piecewise-affine map that is uniquely determined by setting the mapping of each vertex ᵢ=Φ(vᵢ) An arbitrary simplicial map Φ of the mesh M with a matrix U=[u₁, . . . , uₙ]∈R^{3×n} is presented. The restriction of Φ to each tet tⱼ∈T is an affine map ΦIₜ_{ⱼ}(x)=Aⱼx+δⱼ, where Aⱼ can be defined in terms of the unknowns U via the following linear system:

Aⱼ└vⱼ_{₁}vⱼ_{₂} . . . vⱼ_{₄}┘E=└uⱼ_{₁}uⱼ_{₂} . . . uⱼ_{₄}┘E, (53)
where j₁, . . . , j₄ denote the indices of the vertices of the j'th tet, and E is a (singular) centering matrix given by E=I−1/411^{T}. This enables us to express the matrices Aⱼ as linear functions of the variables U, which are computed at preprocess. This relation is denoted via Aⱼ(U).

The multi-matrix meta-problem can be readily adapted for optimizing simplicial maps with functionals and constraints formulated in terms of singular values:

$$\begin{matrix}{min}_{U ∈ {R}^{3 \times n}} f ( U , … , {A}_{j} , {σ}_{min} ( {A}_{j} ) , {σ}_{max} ( {A}_{j} ) , … ) & ( 54 a ) \\ s . t . {A}_{j} = {A}_{j} ( U ) & ( 54 b ) \\ {g}_{i} ( U , … , {A}_{j} , {σ}_{min} ( {A}_{j} ) , {σ}_{max} ( {A}_{j} ) , … ) \leq 0 & ( 54 c ) \\ det ( {A}_{j} ) \geq 0. & ( 54 d )\end{matrix}$$

In turn, Algorithm 3 is used for its optimization. Unless noted otherwise, Algorithm 3 is initialized with the identity map.

Note that constraining σₘᵢₙ(Aⱼ)≧∈>0, in conjunction with (54d), implies that det(Aⱼ) is strictly positive, which guarantees injectivity in the interior of the j'th tet. Global or local injectivity of the resulting simplicial maps may be further guaranteed with some additional assumptions.

Two standard and popular functionals are used as a baseline for demonstrating the optimization framework:
1. As-Rigid-As-Possible (arap) energy, defined as fₐᵣₐₚ(U)=Σⱼ₋₁^{m}∥Aⱼ−Rⱼ∥_{F}²|tⱼ|, where Rⱼ∈SO(3) is the closest rotation to Aⱼ.
2. As-Affine-As-Possible (aaap) smoothness energy fₐₐₐₚ(U)=Σₜ_{ᵢ}_{:t}_{ⱼ}∥Aᵢ−Aⱼ∥_{F}²(|tᵢ|+|tⱼ|), where tᵢ:tⱼ implies two tets sharing a face.

The aaap functional is quadratic and convex, and hence fits into the present invention's meta-problem framework. The arap functional is not convex, however for fixed R₃ it is quadratic and convex and fits into the meta-problem as well.

Both these functionals do not avoid flipping tets and may introduce arbitrarily high element distortion as shown in FIG. 16: (a) shows an arap deformation result (a bar is deformed, where the green areas depict the hard positional constraints used) which exhibits flipped tets and conformal distortion above 300, and (d) shows an aaap deformation result leading to conformal distortion above 8.

Constraints.

The first goal is to introduce spaces of 3D simplicial maps, that are orientation preserving (with no flipped tets) and have bounded amount of distortion. Expressed are these in terms of constraints that involve singular values and demonstrate that optimizing functionals, such as arap or aaap, over these spaces produces plausible deformations. Three flavors of spaces are experimented, where the meta-problem is initiated with the introduction of constraint functions g that satisfy the monotonicity condition:
1. k-bounded isometry (bi) maps forbid lengths to change by a factor greater than k. Namely, they satisfy k⁻¹≦σₘᵢₙ(A₃)≦σₘₐₓ(Aⱼ)≧k. This formulates in the present framework as the constraint functions g_{j,1}(U)=σₘₐₓ(Aⱼ)−k, and g_{j,2}(U)=k⁻¹−σₘᵢₙ(Aⱼ).
2. k-bounded scaled isometry (bsi) maps allow bounded k-isometric distortion with respect to a global isotropic scale s>0. That is, sk⁻¹≦σₘᵢₙ(Aⱼ)≦σₘₐₓ(Aⱼ)≦sk. Taking s as a slack variable, this can be expressed as g_{j,1}(U,s)=σₘₐₓ(Aⱼ)−sk, and g_{j,2}(U,s)=sk⁻¹−σₘᵢₙ(Aⱼ)
3. k-bounded conformal distortion (bcd) maps forbid local length ratios to change by a factor greater than k. Thus, satisfying σₘₐₓ (Aⱼ)≦kσₘᵢₙ(Aⱼ) which is expressed via gⱼ(U)=σₘₐₓ(Aⱼ)−kσₘᵢₙ(Aⱼ).

FIG. 16: (b),(e) shows the result of optimizing the arap, aaap (resp.) restricted with the k-bounded conformal distortion, for k=2. (c),(f) show the same functionals constrained with k-bounded scaled isometry. In both cases, the respective distortion in the final deformation is globally bounded by 2 and no tets are flipped.

Schüller et al., 2013 introduced a barrier formulation to avoid flipping tets during optimization of similar energies, however their method is limited to the constraint det(Aⱼ)≧0 and cannot handle more elaborate singular value constraints. Aigerman and Lipman 2013 suggest an algorithm for projecting simplicial maps onto the set of bounded distortion maps, however this projection looks for a map close to an input initial map, and does not directly optimize a given energy. The present invention's algorithm directly optimizes any convex energy over the space of bounded distortion maps. Table 2 compares the volumetric parameterization examples from Aigerman's paper to mappings achieved by minimizing the same energy (Dirichlet) using the present algorithm, initialized by their results. Note that in all cases the Dirichlet energy of the map is decreased (using the same bounds on the conformal distortion). See also FIGS. 17A and 17B for a visual comparison.

TABLE 2
Volumetric parameterization - comparison to Aigerman and
Lipman 2013. fₒᵤᵣ and f_{aig} are the Dirichlet energies of
the present invention and Aigerman and Lipman solutions,
respectively, and #ᵢₜₑᵣ is the number of iterations the
present invention's algorithm ran until convergence.

| | Verts | Tets | fₒᵤᵣ | f_{aig} | #ᵢₜₑᵣ |
|---|---|---|---|---|---|
| Duck | 7k | 13k | 10.4 | 11.0 | 3 |
| Max Plank | 30k | 40k | 11.0 | 12.5 | 3 |
| Hand | 25k | 41k | 10.3 | 11.8 | 3 |
| Sphinx | 32k | 43k | 3.8 | 4.1 | 3 |
| Bimba | 32k | 45k | 12.0 | 13.1 | 4 |
| Rocker | 37k | 60k | 26.3 | 36.0 | 4 |

Functionals. The present invention's framework further enables optimizing certain functionals that are formulated directly in terms of the singular values of the transformation matrices Aⱼ. Several functionals are explored that generalize conformal mappings to 3D:
1. Least-Squares-Conformal-Maps (lscm) Lévy et al. 2002 [L´EVY, B., PETITJEAN, S., RAY, N., AND MAILLOT, J. 2002. Least squares conformal maps for automatic texture atlas generation. ACM Trans. Graph. 21, 3 (July), 362-371] can be generalized to any dimension by minimizing the spread of the singular values, i.e. the functional f_{lscm}(U)=Σⱼ₌₁^{m}[σₘₐₓ(Aⱼ)−σₘᵢₙ(Aⱼ)]²|tⱼ|. This reduces to lscm in 2D, however it is no longer convex when considered in dimensions higher than two. Nonetheless, it is convex as a function of the singular values themselves and satisfies the monotonicity condition, and therefore can be optimized in the proposed framework.
2. Sparse-Conformal-Maps (11 cm) is an l₁ version of the lscm functional defined by f_{l1cm}(U)=Σⱼ₌₁ⁿ[σₘₐₓ(Aⱼ)−σₘᵢₙ(Aⱼ)]|tⱼ|, which intuitively concentrates distortion in a sparse manner
3. Extremal Quasiconfonnal Distortion (eqc) aims at minimizing the maximal conformal distortion and is defined via f_{eqc}(U)=maxⱼ{σₘₐₓ(Aⱼ)/σₘᵢₙ(Aⱼ)}. This functional is more challenging as it is not convex even when considered as a function of σₘᵢₙ and σₘₐₓ, however it is quasi-convex and satisfies the monotonicity condition. It is shown next that the present framework can be extended to enable its optimization as well.

FIG. 16: (g)-(j) shows deformations of a bar with these functionals. lscm and l1cm strive to minimize deviation from conformality, in the sense of minimizing the deviation from Cauchy-Riemann-type equations. eqc directly minimizes the maximal conformal distortion. (j) shows two distributions of conformal distortion, highlighting the difference between the lscm and eqc solutions: the eqc achieves much lower maximal conformal distortion than the lscm solution (as indicated by the triangles). Another interesting aspect is that eqc achieves almost constant conformal distortion, with most tets having distortion just below the maximal value. Although this behavior is well understood for extremal quasiconformal maps in 2D, we are unaware of any results of this kind for extremal quasiconformal maps in 3D. This optimization tool can be used to gain a first glimpse of these fascinating maps. FIGS. 15, 18(a)-(c) depict a few extremal quasiconformal maps computed with the present invention's method (fully described below), by placing point constraints on a volume and moving them around. Note that although only the maximal conformal distortion is optimized, the minimizers are highly regular. This regularity is not trivial and indicates that this problem has an interesting underlying structure.

Minimizing Maximal Conformal Distortion.

Let us provide more details on the optimization of the eqc functional described above, as it deviates from the present general framework. The core idea is to use its quasi-convex structure. For a fixed k, considered is the following optimization problem:

$${min}_{U ∈ {R}^{3 \times n}} τ$$

$$s . t . {σ}_{max} ( {A}_{j} ) \leq k {σ}_{min} ( {A}_{j} ) + τ , j = 1 … m$$

with additional linear constraints on some of the columns of U. For example, positional constraints of the form uᵢ=wᵢ.
This can be interpreted as a k-bcd feasibility problem, where one seeks a map with maximal conformal distortion k. In fact, if a solution with τ<0 is found, it is guaranteed to have maximal conformal distortion strictly below k; this follows by noticing that

$$\frac{{σ}_{max}}{{σ}_{min}} \leq k + \frac{τ}{{σ}_{min}} < k for τ < 0.$$

For a fixed k≧1, this problem can be cast into the present framework (54) with the choice

f(τ,U, . . . )=τ (55a)

gⱼ(τ,U, . . . )=σₘₐₓ(Aⱼ)−kσₘᵢₙ(Aⱼ)−τ, (55b)
for j=1, . . . , m. These functions are convex in σₘᵢₙ and σₘₐₓ and satisfy the monotonicity conditions.

Algorithm 3 is used with eqs. (55), starting with k>>1 (using k=50). Once a solution with τ<0 is found, reset k=maxⱼ{σₘₐₓ(Aⱼ)/σₘᵢₙ(Aⱼ)} and reiterate Algorithm 3 until k has converged. Once an initial feasible result is found, each such iteration is guaranteed to be feasible, with monotonically decreasing maximal conformal distortion. See FIG. 18 for examples of extremal quasiconformal mappings.

### Non-Rigid ICP

The present invention's framework is used to introduce an alternative deformation model to a non-rigid Iterative Closest Point (ICP) framework. It is suggested to directly control the deformation in terms of the maximal isometric distortion. It is demonstrated how this leads to a more robust version of non-rigid ICP, producing favorable results compared to a baseline algorithm. Additional technical details on the implementation are provided in the supplementary material.

Non-rigid ICP is a popular variant of the classical ICP algorithm. It aims to find a mapping Φ that registers two deformable surfaces S and T embedded in 3D.

Deformation Model

A deformable tetrahedral mesh is used to model volumetric deformations of the source mesh S. A deformation of the volume Φ then naturally induces a deformation of the source surface, which is denoted by Φ(S).

For each point p∈Φ(S) the closest point p′∈T is computed and vice-versa for q∈T compute its closest q′∈Φ(S). It is then defined a fitting energy by

$${f}_{fit}^{2} ( Φ ) = {\sum }_{p ∈ Φ ( S )} {w}_{p} {‖ p - {p}^{′} ‖}^{2} + {\sum }_{q ∈ T} {w}_{q} {‖ q - {q}^{′} ‖}^{2} \qquad ( 56 )$$

where wₚ is determined by the resemblance of the Heat Kernel Signatures (HKS) Sun et al. 2009 [SUN, J., OVSJANIKOV, M., AND GUIBAS, L. 2009. A concise and provably informative multi-scale signature based on heat diffusion. In Proc. Eurographics Symposium on Geometry Processing, 1383-1392] of p and its closest point p′ on Φ(S); w_{q} is defined similarly (see supplementary material).

An auxiliary tetrahedral mesh M=(V, T) is used to define the deformation model. The deformation is then simply Φ=Φ_{U}, a simplicial volumetric map defined in terms of U∈R^{3×n}, as described in subsection Simplicial maps of meshes.

The invention uses either (i) a tetrahedral mesh enclosing the surface S (for space warping) or (ii) a mesh enclosed by the surface S (for articulation), see FIG. 19. In the first case, each surface point p∈S is encoded by its barycentric coordinates inside the relevant tet of M. In the second case, the deformation mesh M does not necessarily contain S, as seen in the FIG. 19; in this case p in encoded as a linear combination of nearby vertices of M, using a linear moving least squares approximation (additional details in the supplementary). In both cases, the deformed surface Φ(S) is represented as a linear function of the variables U.

Optimization of Baseline Non-Rigid ICP.

Baseline algorithm is first described to be compared with the algorithm of the present invention. This algorithm seeks to find a deformation Φ that minimizes

f(Φ)=λ_{f}f_{fit}(Φ)λₛfₛₘₒₒₜₕ(Φ)λᵣf_{rigid}(Φ), (57)
where fₛₘₒₒₜₕ and f_{rigid} regularize the deformation. For the smoothness term fₛₘₒₒₜₕ (Φ) the aaap energy is used, and for f_{rigid} the arap energy is used, which penalizes for deviations from rigidity. (Both aaap and arap energies are defined in Section Simplicial maps of meshes.)

Note that f(Φ) is a convex quadratic function of the variables U. It is optimized, following a standard ICP approach, by alternating between the following two steps:
1. For each p∈Φ(S) compute the closest point p′∈T and vice-versa for q∈T compute its closest q′∈Φ(S).
2. Optimize f(Φ) given in equation (57).

In order to allow the surface S to gradually deform and fit to the target surface T, the coefficient λᵣ of the rigidity term is decreased with each iteration. Thus, allowing increasing levels of deformation. It is chosen to set Aᵣ⁽ⁿ⁾=λᵣ^{max}/δₙ in the n'th iteration for δ>1, until reaching a minimal value λᵣ^{min}.

Non-Rigid ICP with Bounded Isometric Distortion.

Finding the balance between the different terms of eq. (57) is not straightforward and is usually resolved heuristically, as suggested above. Specifically, it is unclear how to set λᵣ to allow only a certain amount of deformation. Furthermore, popular deformation energies, such as the arap energy, often concentrate isometric distortion unevenly, resulting in strong volumetric distortion and possibly non-injective maps. Consequently, the deformed surface Φ(S) suffers from the same problems as well. Thus, difficult fine-tuning may be required in order to approach state-of-the-art performance.

Instead, it is suggested to simply replace the rigidity term in the functional (57) with the k-bounded scaled isometry constraint (bsi). Then, increasing k in each iteration of the algorithm directly controls the maximal isometric distortion allowed for Φ, thus avoiding the question of balancing the different energy terms.

Therefore, step (2) of the baseline ICP algorithm is replaced with the minimization of a simpler functional:

f(Φ)=λ_{f}f_{fit}(Φ)+λₛfₛₘₒₒₜₕ(Φ),
subject to the constraint that Φ is k-bounded scaled isometry. Optimization is performed using Algorithm 3, as described in Simplicial maps of meshes. The bound k is linearly increased k⁽ⁿ⁾=1+nΔ, until reaching a maximal value kₘₐₓ. In particular, for k=1 the model reduces to the classical ICP algorithm, as the only simplicial maps Φ with scaled isometric distortion of 1 are global similarity transformations. Thus, the algorithm gradually transitions from classical ICP to non-rigid ICP. It is denoted that this algorithm as bsi-ICP.

Anatomical Surfaces Dataset.

In the first experiment the baseline non-rigid ICP is compared with the bsi-ICP algorithm on three datasets of anatomical surfaces (bones) taken from Boyer et al. 2011 [BOYER, D. M., LIPMAN, Y., ST. CLAIR, E., PUENTE, J., PATEL, B. A., FUNKHOUSER, T., JERNVALL, J., AND AUBECHIES, I. 2011. Algorithms to automatically quantify the geometric similarity of anatomical surfaces. Proceedings of the National Academy of Sciences 108, 45, 18221-18226] which include 217 pairs of surfaces extracted from volumetric CT scans. The motivation here is to achieve well-behaved volumetric deformations that best fit the surfaces.

FIG. 20 shows the result of the baseline ICP compared to the bsi-ICP on a few sample pairs of surfaces. FIGS. 21A and 21B depict the tradeoff between the fitting energy and the amount of distortion and flipped tets over the entire dataset. It summarizes the results obtained with the two algorithms, where common parameters are set the same. Note that the bsi-ICP achieves similar fitting energy while maintaining a much lower distortion than the baseline and without introducing any flipped tets.

Other Models.

The bsi-ICP algorithm was also tested on different models from the SCAPE (Anguelov et al. 2005 [ANGUELOV, D., SRINIVASAN, P., KOLLER, D., THRUN, S., RODGERS, J., AND DAVIS, J. 2005. Scape: Shape completion and animation of people. ACM Trans. Graph. 24, 3 (July), 408-416]) and SHREC (2007 Giorgi et al. 2007 [GIORGI, D., BIASOTTI, S., AND PARABOSCHI, L., 2007. Shape retrieval contest 2007: Watertight models track. GOEMANS, M. X., AND WILLIAMSON, D. P. 1995 Improved approximation algorithms for maximum cut and satisfiability problems using semidefinite programming J ACM 42, 6 (November), 1115-1145]) datasets. These models are more challenging for ICP-type algorithms due to the large changes of pose (SCAPE) and shape (SHREC). Nevertheless, it is found that in many cases merely initializing the bsi-ICP with a reasonable rigid motion is enough to achieve good fitting results, as is demonstrate next.

FIG. 27 shows the deformation sequence for bsi-ICP (top row) and the baseline algorithm (bottom row) for a pair of SCAPE models. Note that the bounded-isometric deformation model better preserves the shape of the model during deformation and at the end result. FIG. 22 shows a collection of results of the bsi-ICP algorithm on pairs of SCAPE models. Note that the algorithm is able to reproduce rather large deformations with only an initial rigid alignment as input. Bottom row shows failure cases, in which wrong correspondences, due to the use of Euclidean closest point matching, led to bad alignment.

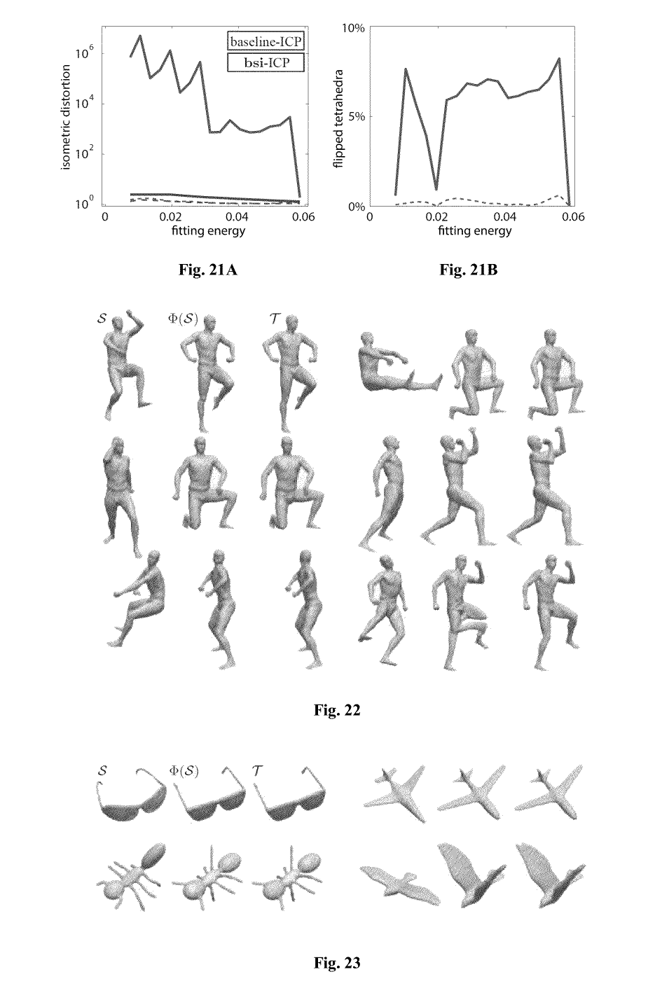

The SHREC dataset is extremely challenging as inter-class surfaces introduce large shape variability and a simple deformation model (i.e., volumetric deformations of an auxiliary mesh M) no longer well-represents the deformation between arbitrary pairs. Nevertheless, FIG. 23 shows that in some cases the bsi-ICP achieves pleasing results with pairs of the same class.

### 11.3 Averaging Rotations

In this last application it is exemplified how the present invention's framework applies to different types of problems than optimization of simplicial maps. The classical problem of averaging of rotations are chosen; that is, given a set of rotations R¹, . . . , R^{k}∈SO(3) and non-negative weights w₁, . . . , wₖ that sum up to one, it is required to calculate a rotation R* that plays the role of their weighted average. One way to define an average is via the Karcher mean, which generalizes the Euclidean mean to the manifold case Karcher 1977 [KARCHER, H. 1977. Riemannian center of mass and mollifier smoothing. Comm pure and applied mathematics 30, 5, 509-541]:

$${R}^{*} = arg {min}_{R ∈ SO ( 3 )} {\sum }_{j = 1}^{k} {w}_{j} {dist ( R , {R}^{j} )}^{2} , \qquad ( 58 )$$

where dist(R,R^{j}) is the geodesic distance between the two rotations in the rotation manifold SO(3).

Methods for approximating the Karcher mean on either the manifolds of rotations or PSD matrices have been studied usually using local gradient or Newton methods, while taking advantage of the log exp maps, and typically require fine tuning (e.g., of line search step size). In computer graphics, Alexa 2002 defined averages of transformations by exploiting the linear structure at the tangent space (using the log and exp maps). Rossignac and Vinacua 2011 [ROSSIGNAC, J., AND VINACUA, A. 2011. Steady affine motions and morphs. ACM Trans. Graph. 30, 5 (October), 116:1-116:16] consider the interpolation of pairs of affine transformations; they further determine the conditions on which this interpolation is stable. It is shown that the problem of averaging rotations can be cast into the invention's framework, producing approximations to the weighted Karcher mean, without computing the log or exp of any transformations. Starting with showing how to approximate geodesics on the rotation group and then extend it to the weighted Karcher mean of several rotations, eq. (58).

Discretization of geodesics on SO(3). Constant speed geodesics γ:[0,1]→SO(3) on SO(3), seen as a Riemannian manifold, can be formulated in a variational form as critical points of the energy functional

f(γ)=∫₀¹∥\dot{γ}(t)∥_{F}²dt. (59)
In the discrete case, the unit interval is subdivided into equal-length segments 0=t₀<t₁< . . . <tₙ=1, where Δt=tᵢ₊₁−tᵢ=1/n and consider the piecewise linear curve γ=[R₀, R₁, . . . , Rₙ]. Observing that \dot{γ}(t)=n(Rᵢ₊₁−Rᵢ) for t∈(tᵢ₊₁,tᵢ), f(γ) is calculated using eq. (59):

$$f ( ϒ ) = {\sum }_{i = 0}^{n - 1} {\int }_{{t}_{i}}^{{t}_{i + 1}} {‖ \dot{ϒ} ( t ) ‖}_{F}^{2} d t = n {\sum }_{i = 0}^{n - 1} {‖ {R}_{i + 1} - {R}_{i} ‖}_{F}^{2} . \qquad ( 60 )$$

Note that this discretization satisfies two desirable properties, similarly to the continuous case: (i) length(γ)²=[Σᵢ₌₁ⁿ⁻¹∥Rᵢ₊₁−Rᵢ∥_{F}]²≦nΣᵢ₌₁ⁿ⁻¹∥Rᵢ₊₁−Rᵢ∥_{F}²=f (γ), and (ii) if γ is of constant speed, that is ∥Rᵢ₊₁−Rᵢ∥_{F}=c, then length(γ)²=f(γ). It is noted that length(γ) is a discrete approximation to dist(R⁰Rⁿ).

Therefore, one can calculate geodesics on SO(3) between two rotations Gₐ and G_{b} by minimizing f(γ) subject to the constraint that R₀=Gₐ, Rₙ=G_{b}, and Rᵢ∈SO(3). The latter constraint is not convex, as the rotation group is not a convex set. However, since the functional f(γ) is contractive, it is sufficient to constrain αₘᵢₙ(Rᵢ)≧1. This leads to the following optimization problem:

min f(γ) (61a)

s.t. σₘᵢₙ(Rᵢ)≧1,i=1, . . . ,n−1 (61b)

R₀=Gₐ,Rₙ=G_{b}. (61c)

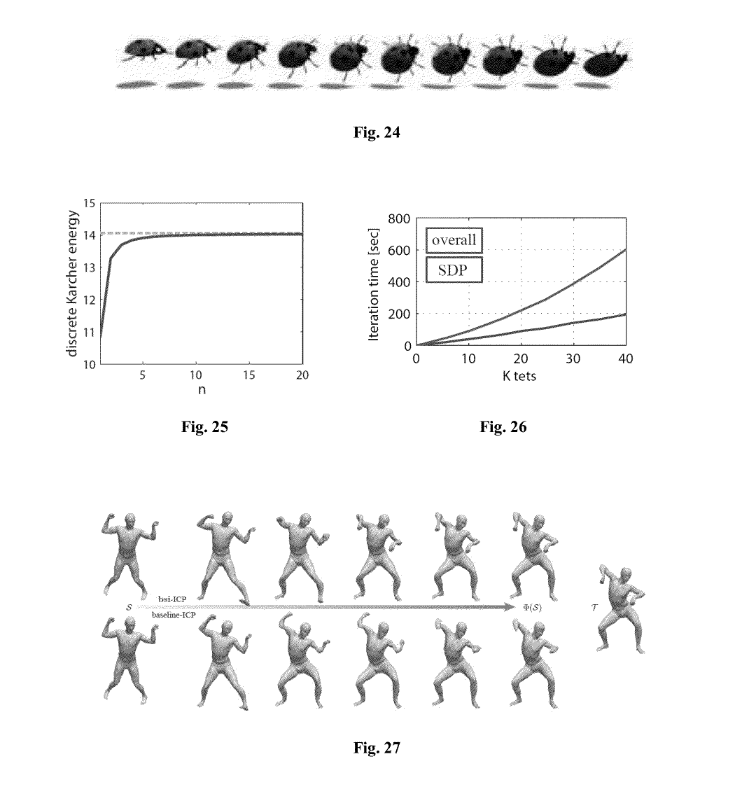

Note that f(γ) is a convex quadratic function in the matrices Rᵢ and the constraint αₘᵢₙ(Rᵢ)≧1 can be easily realized in the present framework. Hence, one can optimize (61) using Algorithm 3. Rᵢ is initialized with the linear interpolant Rᵢ=(1−tᵢ)Gₐ+tᵢG_{b}. Empirically, it is observed that this minimization results in a piecewise linear curve γ of a constant speed; moreover, it precisely reproduces the geodesic in SO(3) at times t, (as can be computed, e.g, with SLERP (Shoemake 1985 [SHOEMAKE, K. 1985. Animating rotation with quaternion curves. SIGGRAPH Comput. Graph. 19, 3 (July), 245-254]). FIG. 24 demonstrates a result of such an optimization.

Karcher Mean.

Optimizing the weighted Karcher mean, eq. (58). Recall that the aim is to compute the weighted average of the rotations R¹, . . . , R^{k}. To this end, employed are the geodesic discretization by defining k piecewise linear curves γ^{j}=[R₀^{j}, R₁^{j}, . . . , Rₙ^{j}], where R₀^{j}=R^{j}. Optimizing

$$\begin{matrix}{min}_{R , {R}_{i}^{j} ∈ {R}^{3 \times 3}} {\sum }_{j = 1}^{k} {w}_{j} f ( {ϒ}^{j} ) & ( 62 a ) \\ s . t . {σ}_{min} ( {R}_{i}^{j} ) \geq 1 , ∀ i , j & ( 62 b ) \\ {R}_{n}^{j} = R , {R}_{0}^{j} = {R}^{j} . ∀ j & ( 62 c )\end{matrix}$$

Following the observations above, constant speed minimizers of (21) satisfy f(γ)=length(γ^{j})²≈dist(R^{j},R)², and therefore the minimizer R of problem (62) is the present approximation of the weighted Karcher mean.

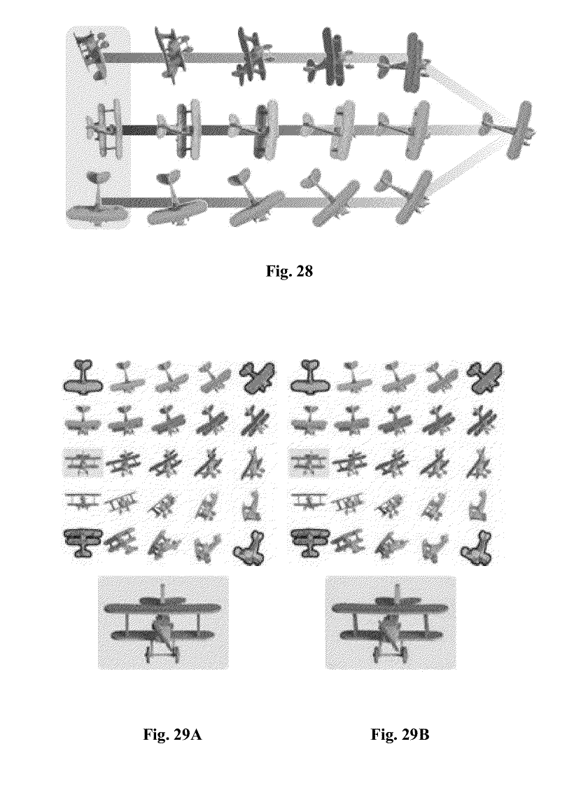

As before, this problem fits into the present invention's optimization framework and can be solved with Algorithm 3. The algorithm is initialized in two steps: first, solving (22) with n=1 (single segment geodesics) with R initialized as the Euclidean centroid of R¹, . . . , R^{k}; then, initializing each of the geodesics R^{j}→R by optimizing (61). It is noted that the Karcher mean on the Rotation group SO(3) is unique if all rotations R¹, . . . , R^{k} belong to a ball (on the manifold) of diameter at most π. FIG. 25 shows the discrete Karcher energy eq. (62a) as a function of the number of segments n used in each geodesic. As expected, the energy is increasing and converging. (Recall that the discrete piecewise linear curves “short-cut” the rotation manifold.) FIG. 28 shows the result of optimizing (59). The rotation on the right hand side is the approximate Karcher mean R*, and each row illustrates the geodesic R^{j}→R*.

FIGS. 29A and 29B show an application of the weighted Karcher mean for exploring rotations. In this case, the inputs are the four rotations in the corners (highlighted with solid borders); different weighted combinations of these rotations, with the present invention's approximation and Alexa 2002, are shown on a grid. Note that Alexa's averaging, although mathematically elegant, does not produce exact geodesics on the borders of the square; namely, it deviates from the in-plane rotation, as emphasized in the blow-up. Rossignac and Vinacua 2011 can also be used to produce similar output (BiSAM), however, unlike the present averaging their approach is limited to generating tensor-product patterns.

### Implementation Details

The present invention's algorithm is implemented in Matlab, using YALMIP for the modeling of semidefinite programs (L\ddot{}ofberg 2004 [L\ddot{}OFBERG, J. 2004. Yalmip: A toolbox for modeling and optimization in MATLAB. In Proceedings of the CACSD conference]) and MOSEK (Andersen and Andersen 1999 [ANDERSEN, E. D., AND ANDERSEN, K. D. 1999. The MOSEK interior point optimization for linear programming an implementation of the homogeneous algorithm. Kluwer Academic Publishers, 197-232]) for its optimization. All timings were measured on a single core of a 3.50 GHz Intel i7. FIG. 26 shows typical run-times of a single iteration of Algorithm 3, used for bcd-constrained deformations of tetrahedral meshes of various sizes. Roughly half the time is spent on the semidefinite optimization (MOSEK), while the rest is an overhead spent on problem setup (YALMIP); a more efficient implementation can significantly reduce this overhead. It is further noted that the present SDP model is quite untypical (e.g., has extremely many low-dimensional LMI constraints, much more than the number of variables); thus, standard SDP solvers may be non-optimal. Typical overall optimization time in several of the applications herein: Computation of Karcher mean with 5 links took 2 seconds (FIG. 28); volumetric parameterization converged in 3-4 iterations, which took 28 minutes for the Max Plank model with 40k tets (FIGS. 17A and 17B); extremal quasiconformal deformation of a cube with 16.5k tets converged in 11 iteration which took 46 minutes (FIG. 15); non-rigid ICP registration took less than 20 minutes for each pair of the anatomical surface dataset (FIG. 20) and 1 hour for a pair of SCAPE models (FIG. 27).

### Concluding Remarks

In the present invention, a framework for optimizing a family of problems formulated in terms of the minimal and maximal singular values of matrices is developed. The present invention uses linear matrix inequality constraints to characterize maximal convex subsets of the set of orientation preserving matrices whose singular values are bounded. This leads to an effective convex optimization framework for an entire class of highly non-convex problems, and, in turn, to a single algorithm that applies to a variety of geometry processing problems. The present invention applies this method to a collection of problems in computer graphics, and expect to find more applications in related fields.

As of the present time, the main limitation of the proposed framework is its time complexity. SDP solvers still lag behind simpler conic solvers and optimization time may be considerable, as described above. Nevertheless, it is assumed that a customized SDP solver, tailored to the structure of problems that arise in computer graphics, can be designed and has the potential for significant speed-up.

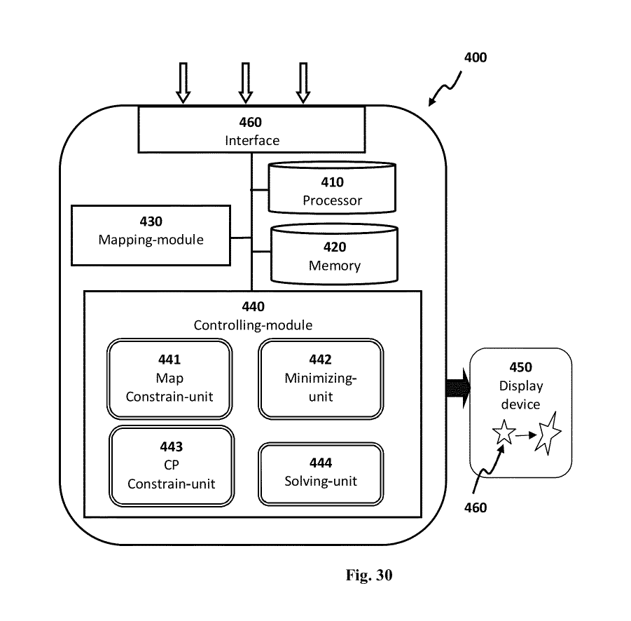

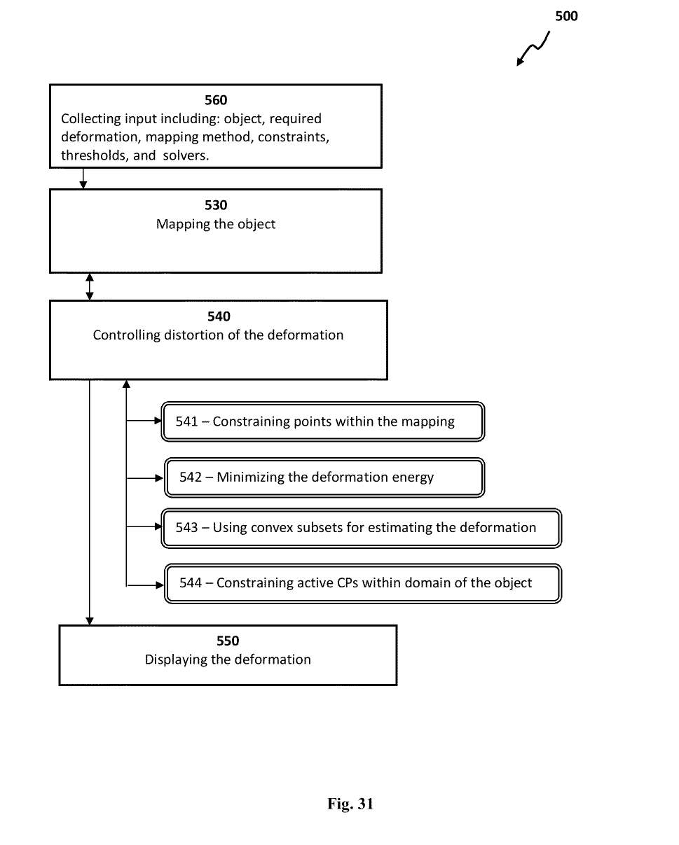

Reference is now made to FIG. 30 conceptually illustrating embodiments for the computer system [400] having a memory [420] and a processor [410] configured for simulating deformation of at least one physical object [460], the system comprising:
a mapping-module [430], stored in the memory [420], configured for mapping the object using:
   a mesh of base-shapes, or
   basis functions;
a controlling-module [440], stored in the memory, configured for controlling distortion of the deformation, by constraining or minimizing at least one of:
   isometric distortion,
   conformal distortion, and
   singular values of differentials of the mapping; and
a display device [450] for displaying the deformation.

According to some embodiments, the controlling-module comprising a minimizing-unit [442], stored in the memory, configured for minimizing energy of the deformation.

According to some embodiments, the controlling-module comprising a map-constrain-unit [441], stored in the memory, configured for constraining one or more points in the mapping to at least one of: fixed location, linear subspace, and convex cone; the points responsive to user selection or to predetermined requirement of the deformation; the constraining is either hard constraining or soft constraining

According to some embodiments the controlling-module comprising a solving-unit [443], stored in the memory, configured for:
formulating convex subsets for the distortion of the deformation; the convex subsets are selected from:
   Second Order Cone (SOC) for using a Second Order Cone Programming (SOCP) solver, or
   Linear Matrix Inequalities (LMI) for using a Semi Definite Programming (SDP) solver; and
iterative steps for the controlling of the distortion, the iterative steps comprising:
   estimating the convex subsets,
   selecting a restriction for the estimated convex subsets,
   calculating the deformation using the SOCP solver or the SDP solver for; and
   repeating the steps of the estimating, the selecting and the calculating until changes of the calculated deformation converge to a predetermined deformation-threshold.

According to some embodiments the controlling-module a CP constrain-unit [444], stored in the memory, configured for:
selecting a set of collocation points (CP) [120] within domain of the object, the CP comprising:
   a set of fixed collocation points (FCP), and
   a set of adaptive collocation-points (ACP), the ACP selected responsive to user selection or to predetermined requirement of the deformation;
estimating distortion at each of the CP;
selecting an active set of CP, responsive to a distortion-threshold for the estimated distortion;
enforcing the controlling of the distortion at the active set of the CP.

According to some embodiments the system further comprising an interface [460] configured for at least one of:
collecting the at least one physical object and it's required the deformation;
selecting the basis-functions;
selecting the base-shapes; and
selecting constrains for the distortion.

Reference is now made to FIG. 31 conceptually illustrating embodiments for the method [500] for simulating deformation of at least one physical object, the method using a processor to generate steps of:
mapping [530] the object using:
   a mesh of base-shapes, or
   basis functions;
controlling distortion of the deformation [540], by constraining or minimizing at least one of:
   isometric distortion,
   conformal distortion, and
   singular values of differentials of the mapping; and
displaying the deformation via a display device.

According to some embodiments the method further comprising step of constraining one or more points in the mapping [541] to at least one of: fixed location, linear subspace, and convex cone; the points responsive to user selection or to predetermined requirement of the deformation; the constraining is either hard constraining or soft constraining

According to some embodiments the method further comprising step of minimizing energy of the deformation [542].

According to some embodiments the method further comprising steps of for using convex subsets for estimating the deformation [543], comprising:
formulating convex subsets for the distortion; the convex subsets are selected from:
   Second Order Cone (SOC) for using a Second Order Cone Programming (SOCP) solver, or
   Linear Matrix Inequalities (LMI) for using a Semi Definite Programming (SDP) solver; and
iterative steps for the controlling of the distortion, the iterative steps comprising:
   estimating the convex subsets,
   selecting a restriction for the estimated convex subsets,
   calculating the deformation using the SOCP solver or the SDP solver for; and
   repeating the steps of the estimating, the selecting and the calculating until changes of the calculated deformation converge to a predetermined deformation-threshold.

According to some embodiments the method further comprising constraining active CPs within domain of the object [544] comprising steps of:
selecting a set of collocation points (CP) within domain of the object, the CP comprising:
   a set of fixed collocation points (FCP), and
   a set of adaptive collocation-points (ACP), the ACP selected responsive to user selection or to predetermined requirement of the deformation;
estimating distortion at each of the CP;
selecting an active set of CP, responsive to a distortion-threshold for the estimated distortion;
enforcing the controlling of the distortion at the active set of the CP.

According to some embodiments of the system the method as mentioned above, the controlling of the distortion of the deformation is configured for at least one of: avoiding fold-overs of the object, smoothing the deformation, lowering the isometric distortion, and lowering the conformal distortion.

### Proof A

In the following a computation of the modulus ω_{∇F} of the basis functions used herein as detailed in Table 1. Excluding Thin-Plate Splines, the modulus of all the basis functions [B-Splines and Gaussians] is of the standard Lipschitz type: ω_{∇F}(t)=Lt, where L>0 is called the Lipschitz constant.

Starting by formulating a small lemma that would be of help in calculating the modulus for the Lipschitz case:

Lemma 4

Let g:Ω⊂R²→R be a C² function, where Ω is a convex domain. Then ∇g is L-Lipschitz with

L≦max_{x∈Ω}∥Hg(x)∥₂, [34]

where Hg is the Hessian matrix of g and ∥Hg(x)∥₂ denotes the operator 2-norm of the Hg[x].
Proof Let x, y∈Ω and let γ(t)=(1−t)x+ty, t∈[0,1] be the straight path between x and y, with constant speed and length ∥x−y∥. Then

∇g(y)^{T}∇g(x)^{T}=∫₀¹Hg(γ(t))·γ′(t)dt, (35)
Hence,

$$\begin{matrix}‖ ∇ g ( x ) - ∇ g ( y ) ‖ = ‖ {\int }_{0}^{1} Hg ( γ ( t ) ) \cdot {γ}^{′} ( t ) d t ‖ \\ \leq {\int }_{0}^{1} {‖ Hg ( γ ( t ) ) ‖}_{2} \cdot ‖ {γ}^{′} ( t ) ‖ d t \\ \leq ‖ x - y ‖ {max}_{x ∈ Ω} {‖ Hg ( x ) ‖}_{2} .\end{matrix} \qquad \begin{matrix}( 36 ) \\ \\ ( 37 ) \\ \\ ( 38 )\end{matrix}$$

B-splines. A tensor product of uniform cubic B-splines is used herein. The uniform univariate cubic B-spline B⁽³⁾(x) is classically defined on the interval [0,4], with knot spacing equal to one by,

$$\{ \begin{matrix}\frac{1}{6} {x}^{3} & 0 \leq x \leq 1 \\ \frac{1}{6} ( {x}^{3} - 4 {( x - 1 )}^{3} ) & 1 \leq x \leq 2 \\ \frac{1}{6} ( {( 4 - x )}^{3} - 4 {( x - 3 )}^{3} ) & 2 \leq x \leq 3 \\ \frac{1}{6} {( 4 - x )}^{3} & 3 \leq x \leq 4\end{matrix} . \qquad ( 39 )$$

Uniform cubic B-splines on longer knot vectors are just shifted copies of B⁽³⁾(x). For the present purposes, scaled versions of B⁽³⁾(x) are used, which are defined by

$${B}_{Δ}^{( 3 )} ( x ) = {B}^{( 3 )} ( \frac{x}{Δ} ) .$$

The tensor product is then defined by B_{Δ}⁽³⁾(x)B_{Δ}⁽³⁾(y). By direct computation it can be seen that

$${‖ {Hf}_{i} ( x ) ‖}_{2} \leq \frac{4}{3 {Δ}^{2}}$$

for all x∈R² and by Lemma 4 that

$${ω}_{∇ F} ( t ) = \frac{4}{3 {Δ}^{2}} .$$

Gaussians are examples of radial basis functions Wendland 2004 defined via

$${f}_{i} ( x ) = exp ( - \frac{{‖ x - {x}_{i} ‖}^{2}}{2 {s}^{2}} ) ,$$

where xᵢ∈Ω are called centers, and s>0 is a constant controlling the width of the Gaussian Without loosing generality xᵢ=0 is assumed, and, again, direct calculation shows that

$${‖ {Hf}_{i} ( x ) ‖}_{2} \leq \frac{1}{{s}^{2}}$$

for all xER², and therefore by Lemma 4

$${ω}_{∇ F} ( t ) = \frac{1}{{s}^{2}} t .$$

Thin-Plate Splines [TPS] are also radial basis functions defined via

$${f}_{i} ( x ) = \frac{1}{2} {‖ x - {x}_{i} ‖}^{2} ln {‖ x - {x}_{i} ‖}^{2} .$$

The gradients are ∇ƒᵢ(x)=(x=xᵢ)[1+ln∥x−xᵢ∥²]. It is shown that the situation with TPS is slightly more complicated than with the other bases described above and that their gradients ∇ƒᵢ are locally almost Lipschitz in the sense that the modulus function is of the form ω_{∇F}(t)=(5.8+5|ln t|), for 0≦t≦(1.25e)⁻¹≈0.29. That is, it applies only when ∥x−y∥≦(1.25e)⁻¹. However, this limitation is not important as the fill-distance is in practice always [much] smaller than this constant, and therefore the modulus of continuity is always applied to smaller distances. It is mentioned that although this result is expected to be known, it could not found or an equivalent result in existing literature, accordingly it proved herein.

Assuming w.l.o.g. that xᵢ=0, set τ=1.25 and recall assuming ∥x−y∥≦(τe)⁻¹. First,

∥∇ƒᵢ(x)−∇ƒᵢ(y)∥≦∥x−y∥+∥x ln∥x∥²−y ln∥y∥²∥ [40]

Focusing on the second term, two cases are observed: [i] max {∥x∥, ∥y∥}≧τ∥x−y∥ [e.g., left in FIG. 12B]; and [ii] max {∥x∥, ∥y∥}>τ∥y−x∥ [e.g., right in FIG. 12B].

For case [i], note that the function g(t)=t|ln t²| is monotonically increasing for t∈[0,e⁻¹] and therefore one can replace ∥x∥, ∥y∥ with τ∥x−y∥≦e⁻¹, as follows,

∥x ln∥x∥²−y ln∥y∥²∥≦∥x∥|ln∥x∥²|+∥y∥|ln∥y∥²|≦2τ∥x−y∥|ln τ²∥x−y∥²|.

Combining this with eq. [40] after rearranging,

∥∇ƒᵢ(x)−∇ƒᵢ(y)∥≦∥x−y∥[1+2τ|ln τ²∥+2τ|ln(∥x−y∥²|].
For case [ii], the bound [38] in the proof of Lemma 4 can be refined a bit: Instead of taking the maximum of ∥Hw(x)∥ over all x∈Ω, one can take the maximum over an the points {γ(t)|t∈[0,1] }. In the present case, this is the straight line [1−t]x+ty. Assuming that max {∥x∥, ∥y∥}>τ∥x−y∥, and therefore it can be shown that ∥(1−t)x+ty∥≧(τ−1)∥x−y∥ for all tΣ[0,1] [e.g., by bounding the distance ∥((1−t)x+ty)y∥]. A direct computation shows that

$${‖ {Hf}_{i} ( x ) ‖}_{2} \leq 3 + \vert ln {‖ x ‖}^{2} \vert .$$

### Therefore,

∥Hfᵢ(x)∥₂≦3+|ln(τ−1)²∥x−y∥²|,

on the line [1−t]x+ty, t∈[0,1]. The refined version described above of the bound [38] implies that

∥∇ƒᵢ(x)−∇ƒᵢ(y)∥≦∥x−y∥[3+|ln(τ−1)²|+|ln∥x−y∥²|].

Plugging in τ=1.25 and combining the two cases:

∥∇ƒᵢ(x)−∇ƒᵢ(y)∥≦∥x−y∥[5.8+5|ln∥x−y∥|]

### Proof B

Proving Lemma 2:

Lemma 2.

Let ∇u and ∇v be ω-continuous in Ω. Then both singular values functions Σ and σ are 2ω-continuous.

Proof.

The key to the proof is in equations [19] and [20]. From [19] a modulus of continuity is found for both vector valued functions [maps] J_{S}f and J_{A}f is ω, by noting that the sum [or difference] of ω-continuous maps is 2 ω-continuous. By the triangle inequality their norms are also ω-continuous. Using eq. [20] archives the presented conclusion.

### Proof C

Proof of Maximality.

Assume towards contradiction that there exists a convex set D such that C_{γ}⊂D⊂I_{γ}. Then, let B∈D\C_{γ}, and let B=S+E be its decomposition into a sum of a symmetric and skew-symmetric matrices. Let S=UΛU^{T} be the spectral decomposition of S, with eigenvalues λ₁≧ . . . ≧λₙ. Then B∉C_{γ} implies that λₙ<γ. Below a matrix C∈C_{γ} is found for which

$$\frac{B + C}{2} ∉ {I}_{γ} ,$$

which by convexity entails D [symbol] I_{γ}, in contradiction.

Selecting C to have the form C=UΔU^{T}−E with a diagonal matrix Δ=diag(δ₁, . . . , δₙ whose entries are set as follows: δᵢ=1+2γ+|λᵢ| for i=1, . . . , n−1 and δₙ=γ. Clearly, all the diagonal entries δᵢ≧y and so C∈C_{γ}. However,

$$\frac{B + C}{2} = U \frac{( Λ + Δ )}{2} {U}^{T} ,$$

and the diagonal entries of

$$\frac{Λ + Δ}{2}$$

satisfy

$$\begin{matrix}\frac{{λ}_{i} + {δ}_{i}}{2} > γ \geq 0 & for i = 1 , … , n - 1 and \frac{{λ}_{n} + {δ}_{n}}{2}\end{matrix} < γ .$$

Consequently, the latter entry is either negative, in which case the product of the diagonal values, and hence the determinant, is negative, or it is non-negative and strictly smaller than γ, in which case αₘᵢₙ<γ, therefore

$$\frac{B + C}{2} ∉ {I}_{γ}$$

in contradiction.

Proof of Lemma 3.

Suppose QA∈RC_{γ}. Recall that A=RS. The definition of C_{γ} then implies that R^{T} QRS+SR^{T}Q^{T}R≧2γI. Multiplying by R^{T}Q^{T}R from left and its transpose from right gives SR^{T}QR+R^{T}Q^{T}RS≧2γI, which implies that Q^{T}A∈RC_{γ}.

Meta-Problem Equivalency.

Following, it is proved that the meta-problem [2] is equivalent to formulation [10], expressed in terms of I_{γ}, I^{Γ}:

Suppose A* is optimal in [2] with a*=f(A*,σₘᵢₙ(A*),σₘₐₓ(A*)). Let γ=σₘᵢₙ(A*) and Γ=σₘₐₓ(A*). Clearly (A*,γ,Γ) is feasible in [10] with the same functional value.

Now, let (B*,γ*,Γ*) be optimal in [10] with b*=f(B*,γ*,Γ*). This implies that σₘᵢₙ(B*)≧γ*, det(B*)≧0 and σₘₐₓ(B*)≦Γ*. This, along with the monotonicity conditions, implies that B* is feasible in [2]. Moreover, f(B*,σₘᵢₙ(B*),σₘₐₓ(B*))≦f(B*,γ*,Γ*)=b*.

In order to conclude the proof, it is required to show that B* is in fact optimal in [2]. Assume, towards contradiction, that B′ is feasible in [2] with f(B′)<b*. By the first part of the proof, (B′,σₘᵢₙ(B′),σₘₐₓ (B′)) is optimal in [10] with f(B′,σₘᵢₙ(B′),σₘₐₓ(B′))<b*, in contradiction to the optimality of (B*,γ*,Γ*).

It is understood that various other modifications will be readily apparent to those skilled in the art without departing from the scope and spirit of the invention. Accordingly, it is not intended that the scope of the claims appended hereto be limited to the description set forth herein, but rather that the claims be construed as encompassing all the features of the patentable novelty that reside in the present invention, including all features that would be treated as equivalents thereof by those skilled in the art to which this invention pertains.

1. A computer implemented method for simulating deformation of at least one physical object, said method using a processor to generate steps of:
mapping said object using:
a mesh of base-shapes, or
basis functions;
controlling distortion of said deformation, by constraining or minimizing at least one of:
isometric distortion,
conformal distortion, and
singular values of differentials of said mapping; and
displaying said deformation via a display device.

2. The method according to claim 1, wherein said controlling distortion of said deformation configured for at least one of: avoiding fold-overs of said object, smoothing said deformation, lowering said isometric distortion, and lowering said conformal distortion.

3. The method according to claim 1, wherein at least one of the following holds true:
said object is selected from: two-dimensional image, three-dimensional model, three-dimensional voxel grid, two-dimensional point-cloud, three-dimensional point cloud, three-dimensional surface, two-dimensional video, and three-dimensional video;
said base-shapes are triangles or tetrahedrons; and
said constraining or minimizing of said distortion is enforced according to at least one feature selected from: spatial location and time.

4. The method according to claim 1, wherein said constraining or minimizing of said distortion is uniform over said mapping.

5. The method according to claim 1, further comprising step of minimizing energy of said deformation.

6. The method according to claim 1, further comprising step of selecting said basis functions from the group consisting of: B-Splines, Gaussian, Thin-Plate Splines, and any combination thereof.

7. The method according to claim 1, further comprising step of constraining one or more points in said mapping to at least one of fixed location, linear subspace, and convex cone; said points responsive to user selection or to predetermined requirement of said deformation; said constraining is either hard constraining or soft constraining.

8. The method according to claim 7, further comprising step of minimizing energy of said soft constraining.

9. The method according to claim 1, further comprising steps of
formulating convex subsets for said distortion; said convex subsets are selected from:
Second Order Cone (SOC) for using a Second Order Cone Programming (SOCP) solver, or
Linear Matrix Inequalities (LMI) for using a Semi Definite Programming (SDP) solver; and
iterative steps for said controlling of said distortion, said iterative steps comprising:
estimating said convex subsets,
selecting a restriction for said estimated convex subsets,
calculating said deformation using said SOCP solver or said SDP solver for; and
repeating said steps of said estimating, said selecting and said calculating until changes of said calculated deformation converge to a predetermined deformation-threshold.

10. The method according to claim 1, further comprising steps of
selecting a set of collocation points (CP) within domain of said object, said CP comprising:
a set of fixed collocation points (FCP), and
a set of adaptive collocation-points (ACP), said ACP selected responsive to user selection or to predetermined requirement of said deformation;
estimating distortion at each of said CP;
selecting an active set of CP, responsive to a distortion-threshold for said estimated distortion;
enforcing said controlling of said distortion at said active set of said CP.

11. The method according to claim 1, wherein said deformation is used for computer aided design (CAD) model for said object, or, for registration of at least two of said objects.

12. The method according to claim 11, further comprising step of minimizing of at least one of:
matching energy for said registration; and
energy associated with measuring of physical- and/or geometric-properties of said CAD model.

13. The method according to claim 11, wherein said registration is selected from: image registration, non-rigid shape registration, medical image registration, multi-modal image registration.

14. The method according to claim 11, wherein said CAD comprising a free-form of at least one of: architecture modeling, solid design, solid modeling, and physical simulations.

15. A computer system having a memory and a processor configured for simulating deformation of at least one physical object, said system comprising:
a mapping-module, stored in said memory, configured for mapping said object using:
a mesh of base-shapes, or
basis functions;
a controlling-module, stored in said memory, configured for controlling distortion of said deformation, by constraining or minimizing at least one of:
isometric distortion,
conformal distortion, and
singular values of differentials of said mapping; and
a display device for displaying said deformation.

16. The system according to claim 15, wherein said controlling-module comprising a minimizing-unit, stored in said memory, configured for minimizing energy of said deformation.

17. The system according to claim 15, wherein said controlling-module comprising a map-constrain-unit, stored in said memory, configured for constraining one or more points in said mapping to at least one of: fixed location, linear subspace, and convex cone; said points responsive to user selection or to predetermined requirement of said deformation; said constraining is either hard constraining or soft constraining.

18. The system according to claim 15, wherein said controlling-module comprising a solving-unit, stored in said memory, configured for:
formulating convex subsets for said distortion of said deformation; said convex subsets are selected from:
Second Order Cone (SOC) for using a Second Order Cone Programming (SOCP) solver, or
Linear Matrix Inequalities (LMI) for using a Semi Definite Programming (SDP) solver; and
iterative steps for said controlling of said distortion, said iterative steps comprising:
estimating said convex subsets,
selecting a restriction for said estimated convex subsets,
calculating said deformation using said SOCP solver or said SDP solver for; and
repeating said steps of said estimating, said selecting and said calculating until changes of said calculated deformation converge to a predetermined deformation-threshold.

19. The system according to claim 15, wherein said controlling-module a CP-constrain-unit, stored in said memory, configured for:
selecting a set of collocation points (CP) within domain of said object, said CP comprising:
a set of fixed collocation points (FCP), and
a set of adaptive collocation-points (ACP), said ACP selected responsive to user selection or to predetermined requirement of said deformation;
estimating distortion at each of said CP;
selecting an active set of CP, responsive to a distortion-threshold for said estimated distortion; and
enforcing said controlling of said distortion at said active set of said CP.

20. The system according to claim 15, further comprising an interface configured for at least one of:
collecting said at least one physical object and it's required said deformation;
selecting said basis-functions;
selecting said base-shapes; and
selecting constrains for said distortion.
